(19) United States
(12) Patent Application Publication
(10) Pub. No.: US 2013/0294524 A1
(43) Pub. Date: Nov. 7, 2013

(54) TRANSFORM SKIPPING AND LOSSLESS CODING UNIFICATION

(71) Applicant: QUALCOMM INCORPORATED, San Diego, CA (US)

(72) Inventors: Geert VAN DER AUWERA, San Diego, CA (US); Marta KARCZEWICZ, San Diego, CA (US); Rajan Laxman JOSHI, San Diego, CA (US); Vadim SEREGIN, San Diego, CA (US)

(73) Assignee: QUALCOMM Incorporated, San Diego, CA (US)

(21) Appl. No.: 13/886,210

(22) Filed: May 2, 2013

Related U.S. Application Data
(60) Provisional application No. 61/643,085, filed on May 4, 2012.
(60) Provisional application No. 61/661,229, filed on Jun. 18, 2012.
(60) Provisional application No. 61/668,914, filed on Jul. 6, 2012.

(51) Int. Cl. H04N 7/30

(52) U.S. Cl. CPC H04N 19/00775
USPC 375/240.18

(57) ABSTRACT

An example method includes determining whether an encoded block of residual video data was encoded losslessly in accordance with a lossless coding mode, based on whether transform operations were skipped during encoding of the block of residual video data, and if the block of residual video data was encoded losslessly, then decoding the encoded block of residual video data according to the lossless coding mode to form a reconstructed block of residual video data, where decoding the encoded block of residual data comprises bypassing quantization and sign hiding while decoding the encoded block of residual video data, and bypassing all loop filters with respect to the reconstructed block of residual video data.

This application claims the benefit of U.S. Provisional Application Ser. Nos. 61/643,085, filed May 4, 2012, 61/661,229, filed Jun. 18, 2012, and 61/668,914, filed Jul. 6, 2012, the entire contents of each of which are hereby incorporated by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for signaling data associated with residual video blocks that are encoded losslessly or substantially losslessly, such as residual video blocks that are encoded using a transform skip coding mode or a transquant bypass mode coding mode in video coding.

In one example, a method of decoding video data includes determining whether an encoded block of residual video data was encoded losslessly in accordance with a lossless coding mode, based on whether transform operations were skipped during encoding of the block of residual video data, and if the block of residual video data was encoded losslessly, then decoding the encoded block of residual video data according to the lossless coding mode to form a reconstructed block of residual video data, where decoding the encoded block of residual data comprises bypassing quantization and sign hiding while decoding the encoded block of residual video data, and bypassing all loop filters with respect to the reconstructed block of residual video data.

In another example, a method of encoding video data includes determining whether to encode a block of residual video data losslessly in accordance with a lossless coding mode, based on whether transform operations are skipped during encoding of the block of residual video data, and if the block of residual video data is to be encoded losslessly, then encoding the block of residual video data according to the lossless coding mode, to form an encoded block of residual video data, where encoding the block of residual video data comprises bypassing quantization and sign hiding during encoding the block of residual video data, and bypassing all loop filters with respect to a reconstructed block of video data that is based on the encoded block of residual video data.

In another example, a device for coding video data includes a video coder configured to determine whether to code a block of residual video data losslessly in accordance with a lossless coding mode, based on whether transform operations are skipped during coding of the block of residual video data, and if the block of residual video data is to be coded losslessly, then code the block of residual video data according to the lossless coding mode to form a reconstructed block of residual video data, where, to code the block of residual data, the device is configured to bypass quantization and sign hiding while coding the block of residual video data, and bypassing all loop filters with respect to the reconstructed block of residual video data.

In another example, a device for coding video data includes means for means for determining whether to code a block of residual video data losslessly in accordance with a lossless coding mode, based on whether transform operations are skipped during coding of the block of residual video data to form a reconstructed block of residual video data, and means for, if the block of residual video data is to be coded losslessly, then coding the block of residual video data according to the lossless coding mode, where the means for coding the block of residual data comprises means for bypassing quantization and sign hiding while coding the block of residual video data, and bypassing all loop filters with respect to the reconstructed block of residual video data.

In another example, a computer-readable storage device has stored thereon instructions that, when executed, cause one or more programmable processors of a computing device to determine whether to code a block of residual video data losslessly in accordance with a lossless coding mode, based on whether transform operations are skipped during coding of the block of residual video data, and if the block of residual video data is to be coded losslessly, then coding the block of residual video data according to the lossless coding mode to form a reconstructed block of residual video data, where coding the block of residual data comprises bypassing quantization and sign hiding while coding the block of residual video data, and bypassing all loop filters with respect to the reconstructed block of residual video data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a conceptual diagram illustrating an example coding unit (CU) that a video decoder may receive from a video decoder, in accordance with one or more aspects of this disclosure.

FIG. 5 is a flowchart illustrating an example process that a video decoder, and/or components thereof, may implement, in accordance with one or more aspects of this disclosure.

FIG. 6 is a flowchart illustrating an example process that a video encoder, and/or components thereof, may implement, in accordance with one or more aspects of this disclosure.

### DETAILED DESCRIPTION

HEVC techniques relating to coefficient coding may present one or more potential drawbacks. In various examples, a block of residual video data may be encoded using either a transform skip mode or a transquant bypass mode. In these instances, the block of residual video data may be encoded either losslessly or substantially losslessly. In other words, a video coder may not perform quantization on the encoded block of residual video data, thereby preserving the transform coefficient values such that no accuracy is lost (referred to herein as “losslessly”). However, if other blocks of residual data in the coded picture are coded in a lossy manner (e.g., with some level of quantization, which may refer to rounding), boundary areas between the blocks that were coded in lossless and lossy modes may exhibit some level of blockiness (which may refer to the ability to perceive the square coding units in the reconstructed video data when presented to a viewer). In turn, the resulting blockiness may require filtering by a decoder to remove the blockiness. As one example, an encoder may encode a region of interest (or “ROI”) of a picture losslessly, while encoding other portions of the picture using a lossy mode, which may result in such blockiness that is either apparent to the viewer or smoothed via filtering. A decoder that performs the filtering-based smoothing may require additional syntax overhead and decoder operations, which may or may not be supported by all decoders.

In general, techniques of this disclosure may, in some cases, reduce or potentially eliminate some of the drawbacks described above with reference to coding of blocks of video data according to the HEVC standard. In particular, one objective of the techniques of this disclosure is to improve the signaling and compression of quantization parameters (delta QP) associated with blocks of residual video data. In various implementations of the techniques described herein, a video coder (which may represent a term used to refer to one or both of a video encoder and a video decoder) may enable signaling of a delta QP or determine the value of a QP based on whether or not the block of residual video data was coded losslessly. For instance, the video coder may determine that the block was coded losslessly based on an indication of transform skip mode or transquant bypass mode (also referred to herein as a “transform bypass mode”) being to encode the video data. Transform skip mode and transquant bypass mode are examples of a “lossless transform mode” as used herein. In other words, as used in this disclosure, the term “lossless transform mode” may refer to one or both of transform skip mode and transquant bypass mode. In various implementations of the techniques described herein, the video coder may associate the determined delta QP for a block with a group of blocks or a slice that includes the block.

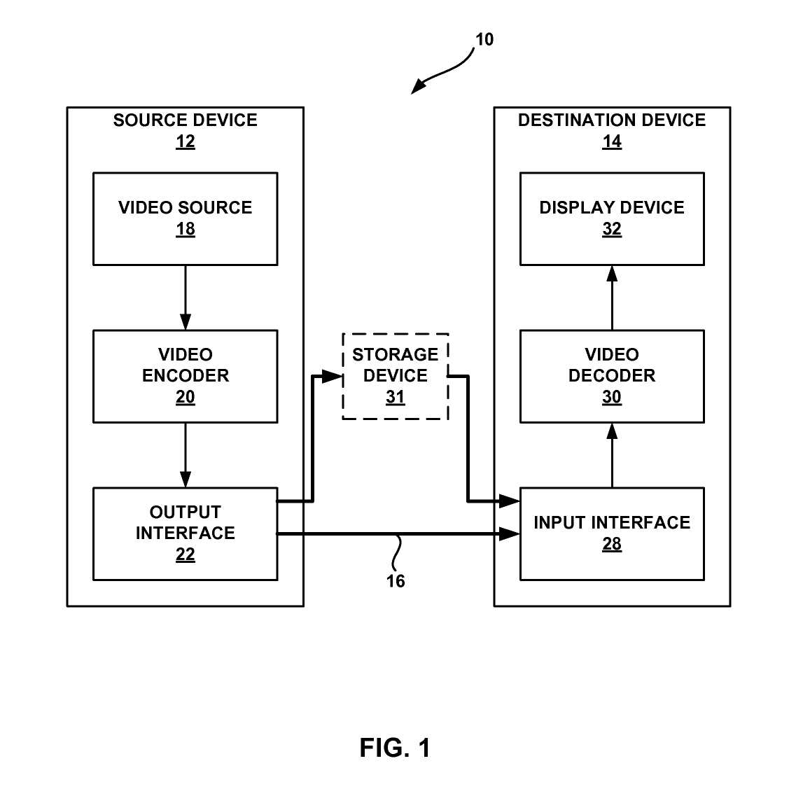

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 31. Similarly, encoded data may be accessed from storage device 31 by input interface. Storage device 31 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 31 may correspond to a file server or another intermediate storage device that may hold the encoded video generated by source device 12. Destination device 14 may access stored video data from storage device 31 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 31 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 31 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 31, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU may include a luma coding block and two chroma coding blocks. The CU may have associated prediction units (PUs) and transform units (TUs). Each of the PUs may include one luma prediction block and two chroma prediction blocks, and each of the TUs may include one luma transform block and two chroma transform blocks. Each of the coding blocks may be partitioned into one or more prediction blocks that comprise blocks to samples to which the same prediction applies. Each of the coding blocks may also be partitioned in one or more transform blocks that comprise blocks of sample on which the same transform is applied.

A size of the CU generally corresponds to a size of the coding node and is typically square in shape. The size of the CU may range from 8×8 pixels up to the size of the treeblock with a maximum of 64×64 pixels or greater. Each CU may define one or more PUs and one or more TUs. Syntax data included in a CU may describe, for example, partitioning of the coding block into one or more prediction blocks. Partitioning modes may differ between whether the CU is skip or direct mode encoded, intra-prediction mode encoded, or inter-prediction mode encoded. Prediction blocks may be partitioned to be square or non-square in shape. Syntax data included in a CU may also describe, for example, partitioning of the coding block into one or more transform blocks according to a quadtree. Transform blocks may be partitioned to be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may represent the TUs. Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more TUs. Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Recently, a transform skipping modification for 4×4 intra predicted TUs has been added to the working draft of HEVC. Except for adding one flag to indicate if a 4×4 intra TU uses transform skipping or not, there was no change to the prediction, de-quantization, scaling, in-loop filters and entropy coding modules. Transform skipping for a 4×4 intra TU is enabled by signaling a transform_skip_enabled_flag in the sequence parameter set (SPS) and by signaling a ts_flag in the residual coding syntax for a TU.

One particular mode for transform skipping for 4×4 intra TU's was proposed in JCTVC-10408, “Intra transform skipping” (C. Lan (Xidian Univ.), J. Xu, G. J. Sullivan, F. Wu (Microsoft), hereinafter “Lan proposal”), which is hereinafter referred to in this disclosure as the “Lan proposal.” The Lan proposal specified the following detail modifications for video coding modules by the transform skip (TS) mode:
(a) Prediction: No change.
(b) Transform: Skipped. Instead, for transform skipping TUs, a simple scaling process is used. Since a 4×4 inverse transform in the current design scales down the coefficients by 32, to let transform skipping TUs have similar magnitudes as other TUs, a scaling-down process by 32 is performed on transform skipping TUs.
(c) De-quantization and scaling. No change.
(d) Entropy coding: A flag for each 4×4 intra TU is sent to indicate if the transform is bypassed or not. Two contexts are added to code the flag for Y, U and V TUs.
(e) Deblocking, SAO and ALF: No change.
(f) A flag in the SPS is signaled to indicate whether transform skipping is enabled or not.
(g) No change to the quantization process for TUs with transform skipping. That is also the case when quantization matrices are used. Because it may not be reasonable to have different quantization parameters according to spatial locations for those TUs with transform skipping, it was also suggested that the default quantization matrix be changed to a flat matrix for 4×4 intra TUs, when transform skipping is enabled. The other reason is that a small transform tends to use a flat quantization matrix. An alternative to this is to leave to the encoder how to better use quantization matrix and transform skipping simultaneously.

In other examples, for TUs of any size or any prediction mode (inter or intra), one or more so-called “transform skip modes” may be supported. With transform skipping, instead of always applying a 2-D transform to a residual block, the transform skipping mode (or modes) may offer more choices. In one example, the transform mode choices may include: 2-D transform, no transform, horizontal transform (vertical transform is skipped), and vertical transform (horizontal transform is skipped). The choice of the transform can be signaled to the decoder as part of an encoded bitstream, e.g., for each block the transform may be signaled or derivable.

The working draft of the HEVC standard also supports coding modes that enable lossless, or substantially lossless coding, of video data. Examples of such coding modes include various transform modes, such as transform skip mode and transquant bypass mode. When encoding video data according to transquant bypass mode, video encoder 20 skips quantization, performing a transform, and passing video data through loop filters. More specifically, the loop filters include one or more of a deblocking filter, a sample adaptive offset (SAO) filter, and an adaptive loop filter (ALF)). According to a previous working draft of HEVC, lossless coding, such as coding according to transquant bypass mode, is enabled for a CU if the value of syntax element qpprime_y_zero_transquant_bypass_flag at sequence parameter set (SPS)-level is enabled, and the quantization parameter (QP'y) equals 0 for the CU.

More recent working drafts of the HEVC standard have been updated to replace the qpprime_y_zero_transquant_bypass_flag with the SPS-level syntax element transquant_bypass_enable_flag in the picture parameter set (PPS) and the cu_transquant_bypass_flag at the CU-level. If both flags are enabled, then the CU is encoded according to a lossless coding mode, such as the transquant bypass mode. Further details on lossless coding can be found in the latest working draft of the HEVC standard, referred to as “HEVC Working Draft 9” or “WD9.” WD9 is described in document HCTVC-K1003, Bross et al., “High Efficiency Video Coding (HEVC) Text Specification Draft 9,” Joint Collaborative Team on Video Coding (JCT-VC) of ITU-T SG16 WP3 and ISO/IEC JTC1/SC29/WG11, 11^{th} Meeting: Shanghai, China, Oct. 10, 2012 to Oct. 19, 2012, which, as of Mar. 21, 2013 is downloadable from http://phenix.it-sudparis.eu/jct/doc_end_user/documents/11_Shanghai/wg11/JCTVC-K1003-v7.zip. WD9 is incorporated by reference herein.

Encoding according to transform skip mode and transquant bypass mode may include one or more overlapping functionalities. Additionally, video encoder 20 may perform certain common interactions with the loop filters (deblocking filter, SAO filter, and/or ALF) when encoding video data according to transform skip mode and transquant bypass mode. As such, if video encoder 20 utilizes signaling according to both transform skip mode and transquant bypass mode, then video encoder 20 may consequently perform duplicative signaling, which in some instances may lead to conflicting signaling. A potential advantage provided by techniques of this disclosure includes unify the coding functionalities provided by transform skipping and the transquant bypass mode.

In various examples of the disclosure, video encoder 20 may integrate the lossless coding features of transquant bypass mode into transform skipping performed in accordance with a transform skip mode. For example, if video encoder 20 applies transform skipping to at least one unit, such as a transform unit (TU), and the video encoder 20 performs the transform skipping based on the value of a signaled flag or on a parameter, such as a quantization parameter (QP), then video encoder 20 may also bypass quantization for the unit, or for a lower level unit included in the unit. More specifically, video encoder 20 may skip the transform and bypass quantization for the unit, based on the value of a signaled flag or the value of a parameter (e.g., QP) that indicates whether to encode the unit according to transform skipping mode.

Conversely, in other examples of this disclosure, video encoder 20 may integrate features of transform skip mode into performance of the transquant bypass mode. For example, if video encoder 20 bypasses both the transform and quantization for at least one unit, such as a coding unit (CU), based on the value of a signaled flag or on a parameter (e.g., QP), then video encoder 20 may enable quantization may be enabled for the unit, or for a lower level unit, such as a TU. Video encoder 20 may enable quantization based on the value of a signaled flag or on the value of a parameter (e.g., QP), used for transform bypass.

In one example implementation of the techniques described herein, video encoder 20 may enable signaling of a QP of a residual block of video data (referred to herein as “delta QP”), based on a prediction mode selected by video encoder 20 with which to encode the residual block of video data. Typically, if video encoder 20 determines that a prediction error has a value of zero, then video encoder 20 may not, in some scenarios, be configured to signal the delta QP. In turn, if video encoder 20 does not signal the delta QP, then video encoder 20 may not be enabled to signal a QP value of four, which is associated with a quantization step size of one, and thus, nonperformance of quantization. Based on the inability of video encoder 20 to signal the QP value of four in such scenarios, video encoder 20 may not guarantee lossless coding, as the QP value of four may indicate lossless coding.

For instance, in this implementation, video encoder 20 may select a particular prediction mode that enables video encoder 20 to signal the delta QP in all scenarios. More specifically, according to this implementation, video encoder 20 may use, or “fall back” on the selected prediction mode if video encoder 20 detects that the residual value is equal to zero. In various examples, the fall back mode may be of either inter-prediction or intra-prediction types. As an example, if video encoder 20 selects an intra-prediction mode, the selected mode may be a particular directional or non-directional intra-prediction mode, corresponding to a particular unit size, such as a transform unit (e.g., 4×4 TU).

In this example implementation, video decoder 30 may determine that an encoded bitstream (e.g., received via link 16), does not include any syntax elements that correspond to a delta QP value for the encoded residual block of video data. In turn, based on the determination that the encoded bitstream received via link 16 does not include any syntax elements that correspond to a delta QP value for the encoded residual block of video data, video decoder 30 may decline to perform one or more functions in decoding the encoded data corresponding to the residual block. As one example, video decoder 30 may decline to apply any inverse transform function to the syntax elements, based on a determination that the residual block was encoded according to a lossless prediction mode, such as transform skip mode. In this and other examples, video decoder 30 may decline to perform any inverse quantization functions, based on a determination that the residual block was encoded according to a lossless prediction mode, such as transquant bypass mode. In this manner, video decoder 30 may, based on video encoder 20 disabling the signaling of a delta QP for an encoded residual block, decline to perform certain functions with respect to decoding the encoded residual block, such applying one or both of inverse transform and inverse quantization functions.

In another example implementation of the techniques described herein, video encoder 20 may force signaling of the delta QP, based on an indication of a particular selected prediction mode. More specifically, in this implementation, video encoder 20 forces the signaling of the delta QP based on detecting that a particular flag is enabled. For instance, video encoder 20 may detect that a cu_transform_skip_flag is enabled, indicating that the block is encoded according to transform skip mode. Similarly, video encoder 20 may detect that a cu_transquant_bypass_flag is enabled, indicating that the block is encoded according to transquant bypass mode. Other examples of flags that video encoder 20 may detect to infer encoding of the lossless encoding of a block include transquant_bypass_enable_flag and/or transform_skip_enable_flag.

According to this implementation, video encoder 20 may force signaling of the delta QP at the beginning of the block, or at the beginning of the block group that includes the block. In the case of forcing the signaling of the delta QP for a block group, video encoder 20 may determine the block group based on a group size, expressed as a finite number of blocks. As one example, video encoder 20 may force signaling of the delta QP, if video encoder 20 detects that one or more of the flags listed above is enabled. More specifically, by forcing signaling of the delta QP, video encoder 20 may indicate to video decoder 30 that the block was encoded losslessly. More specifically, the QP value of 4 may indicate that the encoded data corresponding to the residual block is not quantized.

In this implementation, video decoder 30 may use the signaled delta QP value and/or a signaled indication, such as a flag value, to determine whether or not to perform certain decoding functions with respect to the encoded residual block, or with respect to the designated block group that includes the encoded residual block, as the case may be. In one example, video decoder 30 may detect that a delta QP value of 4 is signaled at the beginning of data associated with a particular encoded residual block. In this example, video decoder 30 may decline to perform any inverse quantization in entropy decoding the encoded residual block, based on a determination, from the delta QP value of 4, that the encoded residual block was not quantized. Additionally, if video decoder 30 determines that a transform skip flag is enabled (e.g., set to a value of one) with respect to the encoded residual block, video decoder 30 may also decline to perform any inverse transform functions in entropy decoding the encoded residual block, based on the lossless nature of encoding associated with a delta QP value of 4.

In another example, video decoder 30 may detect that a QP value of 4 is signaled at the beginning of data associated with a particular block group. In this example, video decoder 30 may decline to perform any inverse quantization (and optionally, any inverse transform) functions in entropy decoding each encoded residual block of the block group. In this manner, video decoder 30 may, based on video encoder 20 forcing the signaling of a delta QP value of 4, decline to perform one or more functions in entropy decoding an encoded residual block and/or a group of encoded residual blocks of video data.

In another implementation of the techniques described herein, video encoder 20 may associate the value of a flag, such as one or both of the cu_transform_skip_flag and the cu_transquant_bypass_flag with a block group that includes the particular residual block, for the purpose of signaling the delta QP value for the block group. More specifically, video encoder 20 may identify the block group based on a number of blocks that define a group size. In various examples, the number of blocks may be associated with a minimum group size to which the signaled delta QP value applies. Video encoder 20 may set the group size value Log₂ MinCUTransquantSize (in the case of transquant bypass mode), or Log₂ MinCUTransformSkipSize (in the case of transform skip mode) based on particular formulas. An example formula that video encoder 20 may use is expressed in the following equation:

Log₂ MinCUgroupSize=Log₂ MaxCUSize−diff_cu_bypass_depth, when the value of diff_cu_bypass_depth>=0.

In the equation above, the term Log₂ MaxCUSize may define a maximum size for a CU, as determined by video encoder 20, and the term diff_cu_transquant_bypass_depth may define a difference between the maximum and minimum sizes for a CU. Another example formula that video encoder 20 may use to determine the value of Log₂ MinCUTransquantSize is expressed in the following equation:

Log₂ MinCUgroupSize=Log₂ MaxCUSize−(diff_cu_bypass_depth−1)

In some instances, video encoder 20 may set the values of one or both of Log₂ MinCUTransquantSize and Log₂ MinCUTransformSkipSize to be equal to the value of Log₂ MinCUDQPSize, which may specify the minimum CU group size defined by video encoder 20 in this implementation of the techniques described herein. In this implementation, Log₂ MinCUDQPSize may specify the minimum CU group size, as well as the minimum CU quantization group size, which Log₂ MinCUDQPSize is traditionally used to specify. In this manner, video encoder 20 may determine a minimum CU group size for signaling the delta QP in accordance with a lossless prediction mode, such as Log₂ MinCUTransquantSize in the case of transquant bypass mode, or Log₂ MinCUTransquantSize in the case of transquant bypass mode, and link an indication of lossless coding to a particular CU group that satisfies the minimum group size. Examples of such indications of lossless coding include the transform_skip_flag and the transform_bypass_flag. By linking such indications of lossless encoding to a CU group, video encoder 20 may enable video decoder 30 to determine whether or not to perform certain decoding functions with respect to each CU of a defined CU group.

Alternatively, video encoder 20 may determine the minimum CU group size using one or more parameters that specify an intra pulse code modulation (IPCM) block size. In various examples, video encoder 20 may signal the IPCM parameters in the picture parameter set (PPS) portion of an encoded bitstream communicated via link 16, or in a slice header portion of the encoded bitstream. Sequence parameter set (SPS) parameters associated with IPCM block sizes are described in table 1 below.

TABLE 1
SPS parameters specifying allowed IPCM block sizes

| seq_parameter_set_rbsp( ) { | Descriptor |
|---|---|
| ..... | |
| if( pcm_enabled_flag \|\| | |
| transquant_bypass_enable_flag \|\| | |
| transform_skip_enable_flag) { | |
| log2_min_pcm_coding_block_size_minus3 | ue(v) |
| log2_diff_max_min_pcm_coding_block_size | ue(v) |
| } | |
| ..... | |

In the table above, the value of log 2_min_pcm_coding_block_size_minus3 specifies a value that is three less than the minimum size of an IPCM coding block. In turn, video encoder 20 may set the value of Log 2 MinIPCMCUSize to three greater than the value of log 2_min_pcm_coding_block_size_minus3. Additionally, video encoder 20 may set the value of Log 2 MinIPCMCUSize to be less than or equal to the value of the lesser of five or the value of Log₂CtbSize. Additionally, video encoder 20 may use the variable log 2_diff_max_min_pcm_coding_block_size to specify a difference between the maximum and minimum sizes of IPCM coding blocks. More specifically, video encoder 20 may set the value of Log₂ MaxIPCMCUSize to be three greater than the sum of the values of value of log 2_min_pcm_coding_block_size_minus3 and log 2_diff_max_min_pcm_coding_block_size.

In this implementation, video decoder 30 may determine the value of one or both of the cu_transform_skip_flag and the cu_transquant_bypass_flag signaled in the encoded bitstream received via link 16. Based on the determined value of the received flag(s), video decoder 30 may determine whether or not to perform one or more operations in entropy decoding the CU group defined by video encoder 20. For instance, if video decoder 30 determines that the value of the cu_transform_skip_flag is set to one (e.g., the cu_transform_skip_flag is enabled), then video decoder 30 may decline to perform any inverse transform operations in decoding any CUs of the defined CU group, based on encoding of at least a portion of the CU group according to transform skip mode. Similarly, if video decoder 30 determines that the value of the cu_transquant_bypass_flag is set to one (e.g., the cu_transquant_bypass_flag is enabled), then video decoder 30 may decline to perform any inverse quantization operations in decoding any CUs of the defined CU group, based on encoding of at least a portion of the CU group according to transquant bypass mode. In some examples, if video decoder 30 detects that either one of the cu_transform_skip_flag or the cu_transquant_bypass_flag is enabled (or that both are enabled), video decoder 30 may decline to perform any inverse transform operations and any inverse quantization operations in decoding any CU of the CU group, based on at least a portion of the CU group being encoded according to a lossless prediction mode.

In another implementation of the techniques described herein, video encoder 20 may signal an indication, such as a flag, as to whether video encoder 20 declined to perform quantization in entropy encoding a residual block, in addition to encoding the residual block according to transform skip mode. As one example, video encoder 20 may generate a flag, such as a “transform_skip_lossless_flag” and signal the generated flag to indicate that video encoder 20 encoded the residual block according to transform skip mode, without performing any quantization operations in the encoding process. In another example, video encoder 20 may signal both the transform_skip_flag and the cu_transquant_bypass_flag, to indicate that video encoder 20 encoded the residual block according to transform skip mode, without performing any quantization operations as part of the encoding process. In examples, video encoder 20 may determine whether the transform_skip_lossless_flag or the cu_transquant_bypass_flag is enabled, based on the value of a higher level flag. An example of such a higher-level flag is a transquant_bypass_enabled_flag, which video encoder 20 may traditionally signal at the PPS-, SPS-, or slice header-level.

Additionally, if video encoder 20 determines that the generated transform_skip_lossless_flag is enabled (or alternatively, that both the transform_skip_flag and the cu_transquant_bypass_flag) are enabled, video encoder 20 may decline to perform certain operations in entropy encoding the residual block, or in encoding a block group that includes the residual block. Examples of operations that video encoder 20 may decline to perform in these scenarios include sign hiding, and loop filtering (e.g., through use of one or more of deblocking, sample adaptive offset, and adaptive loop filters).

In this implementation, in addition to declining to perform the sign hiding and loop filtering operations with respect to the residual block, video encoder 20 may decline to perform any transform operations with respect to a 4×4 block of TUs, based on detecting that the transform_skip_flag is enabled for the residual block. In some examples, video encoder 20 may assign a quantization parameter value QP_{Y} (calculated as a sum of the predictor block QP_{Y} value and the cu_delta_qp value for the block, if any) to the losslessly coded residual block, if the losslessly coded residual block is positioned at a boundary of losslessly coded and lossy coded regions of the picture. By assigning the QP_{Y} value to such a losslessly coded residual block, video encoder 20 may enable deblock filtering of the boundary between losslessly coded and lossy coded blocks. Conversely, if video encoder 20 determines that the generated transform_skip_lossless flag is disabled (e.g., set to a value of zero), then video encoder 20 may assign the QP_{Y} and cu_delta_qp values according to traditional techniques, i.e., through quantization and deblock filtering.

To determine a minimum CU group size according to this implementation, video encoder 20 may use techniques described above with respect to other implementations. As examples, video encoder 20 may apply one or more of the formulas listed above, or apply IPCM block parameters in determining the minimum CU group size. Additionally, video encoder 20 may force signaling of a value for the transform_skip_flag if the generated transform_skip_lossless_flag (or the cu_transquant_bypass_flag) is enabled for a coding unit that includes the 4×4 TUs. Alternatively, if video encoder 20 determines that the transform_skip_lossless_flag is enabled for a CU, then video encoder 20 may determine that the CU includes only 4×4 TUs, and video encoder 20 may enable the transform_skip_flag for each 4×4 TU of the CU. In this example, video encoder 20 may enable the transform_skip_flag for any 4×4 TUs of the CU for which video encoder 20 determines that the transform_skip_flag is absent.

In this implementation, video decoder 30 may determine the value (or enablement status) of one or more flags signaled by video encoder 20, and determine, based on the signaled values, whether or not to perform certain operations in entropy decoding the residual block. For instance, if video decoder 30 determines that the transform_skip_lossless_flag is enabled for the residual block, then video decoder 30 may decline to perform any inverse quantization and any inverse transform operations with respect to the residual block. In accordance with entropy decoding a residual block that was encoded in transform skip mode, if video decoder 30 determines that the transform_skip_flag is enabled for the a residual block, then video decoder 30 may decline to perform any inverse transform operations with respect to the residual block. Similarly, in accordance with entropy decoding a residual block that was encoded in transquant bypass mode, if video decoder 30 determines that the cu_transquant_bypass_flag is enabled for a residual block, then video decoder 30 may decline to perform any inverse transform operations with respect to the residual block. As described, in accordance with this implementation of the techniques described herein, video decoder 30 may receive, via link 16, values of one or more of the transform_skip_lossless_flag, the transform_skip_flag, and the cu_transquant_bypass_flag based on particular determinations with respect to a CU, a minimum CU group, or for 4×4 TUs of a CU.

In another implementation of the techniques described herein, video encoder 20 may generate an indication, such as a slice_ransquant_bypass_flag, associated with encoding of a slice of a picture according to transquant bypass mode. More specifically, video encoder 20 may define the slice_transquant_bypass_flag to apply to an entire slice of the picture, and signal syntax elements corresponding to the value of the slice_transquant_bypass_flag in the slice header over link 16. Additionally, if the slice_transquant_bypass_flag is enabled (e.g., set to a value of one), video encoder 20 may bypass all loop filters (namely, the deblocking filter, SAO filter, and ALF) for samples of the 4×4 TUs of the CUs of the slice, based on the value of the transform_skip_flag of the respective samples. More specifically, if the slice_transquant_bypass_flag is enabled for a current slice, and the transform_skip_flag is enabled for a particular 4×4 TU of the slice, then video encoder 20 may bypass the loop filters for the TU, as well as skip all transform operations with respect to the TU. Additionally, if video encoder 20 detects that the slice_transquant_bypass_flag is enabled, then video encoder 20 may signal one or more syntax elements corresponding to the cu_delta_qp at the beginning of the CU or a minimum CU group that includes the CU.

Additionally, according to this implementation of the techniques, if video encoder 20 detects that the slice_transquant_bypass_flag is enabled for a current slice, and that the QP_{Y} value for a block included in the current slice is four, then video encoder 20 may signal the value of the transform_skip_flag for the block, even if video encoder 20 detects that the value of a coded block flag (cbf) for the block is zero. Alternatively, if video encoder 20 detects that the slice_transquant_bypass_flag is enabled and that the QP_{Y} value for a current block is four, video encoder 20 may determine that any CU of the current slice includes only 4×4 TUs, and the value of the transform_skip_flag for each 4×4 TU of the slice is one. If the conditions of the slice_transquant_bypass_flag being enabled and that the QP_{Y} value for a current block being four are satisfied, and video encoder 20 determines that the transform_skip_flag is absent for a 4×4 TU, then video encoder 20 may additionally determine that the value of the transform_skip_flag for such a 4×4 TU is one.

According to this implementation of the techniques described herein, if video decoder 30 detects that the slice_transquant_bypass_flag is enabled for a current slice in an encoded bitstream received via link 16, and that the transform_skip_flag is enabled for a particular block of the slice, video decoder 30 may not perform any inverse transform operations in entropy decoding the block. Additionally, if video decoder 30 detects that syntax elements signaled via link 16 indicate a QP value of four with respect to a block of the current slice, video decoder 30 may not perform any inverse quantization operations with respect to the block.

In another implementation of the techniques described herein, video encoder 20 may apply one or more bitstream conformance aspects, based on residual data and quantization parameters associated with an encoded block. According to existing coding techniques, video encoder 20 and video decoder 30 may experience a mismatch if the QP value for a predictor block has a value other than four, and a zero residual. More specifically, in the case of such an encoded block, video encoder 20 may not signal a transform_skip_flag, based on the QP value of the predictor block being different from four, and the zero residual value for the block. In turn, because video encoder 20 does not signal a transform_skip_flag in this scenario, video decoder 30 may not have the data necessary to distinguish between coding of a block according to a lossless coding (e.g., transform skip) mode and coding of the block according to a lossy mode.

To mitigate or potentially eliminate issues caused by such mismatch, video encoder 20 may implement one or more techniques of this disclosure to apply bitstream conformance based on QP values and residual data associated with a block. For instance, video encoder 20 may determine, based on certain conditions, that an encoded bitstream that video encoder 20 signals via link 16 does not include data for a block that is encoded according to a lossless coding mode, such as transform skip mode. As one specific example, if video encoder 20 determines that a block has a zero residual value, and that the QP of the block or of the predictor block (also referred to herein as a “predicted QP”) from which the block was predicted has a value of four, then the encoded bitstream does not include any blocks encoded according to a lossless coding mode.

Alternatively, or in addition to the bitstream conformance features described above, video encoder 20 may implement bitstream conformance based on a block having a zero residual and/or the QP value for the current block or the predictor block being different from four. For instance, if video encoder 20 determines that the block has a zero residual and the QP value for the current block or for a corresponding predictor block is different from four, then video encoder 20 may determine that the encoded bitstream does not include a block that is encoded according to a lossy coding mode. In one such example, video encoder 20 may determine that the encoded bitstream only includes blocks that were encoded according to a lossless coding mode, such as transform skip mode or transquant bypass mode.

Alternatively, according to this implementation of the techniques described herein, both video encoder 20 and video decoder 30 may determine (or “infer”) a particular value for the transform_skip_flag for a block. For instance, if a particular block has a zero residual, and the QP for the block or for a corresponding predictor block has a value of four, then video encoder 20 and video decoder 30 may infer that the transform_skip_flag is enabled (e.g., by having a value of one). In other words, under the described set of conditions, video encoder 20 and video decoder 30 may infer that the block is encoded losslessly, such as according to transform skip mode. As another example, if a block has a zero residual and the QP for the block or for a corresponding predictor block has a value other than four, then video encoder 20 and video decoder 30 may infer that the transform_skip_flag is disabled (e.g., by having a value of zero). In other words, under the described set of conditions, video encoder 20 and video decoder 30 may infer that the block is encoded according to a lossy coding mode.

A potential advantage provided by this implementation of the techniques is that video encoder 20 and/or video decoder 30 may use the range of available QP values specified in the current working draft of HEVC. More specifically, video encoder 20 and/or video decoder 30 may assign QP values selected from the range of 0-51. In specific examples, video encoder 20 and/or video decoder 30 may associate a QP value of 4 with a quantization step size of 1. The quantization step size of 1 may be associated with a lossless coding mode, such as transform skip mode and transquant bypass mode. While the lossless coding mode is described herein largely as being associated with a QP value of 4, it will be appreciated that in various examples, video encoder 20 and/or video decoder 30 may detect a lossless coding mode using other QP values, such as another value selected from the available range of 0-51.

In this manner, video encoder 20 may be an example of a video encoder configured to determine whether to encode a block of residual video data losslessly in accordance with a lossless coding mode, based on whether transform operations are skipped during encoding of the block of residual video data, and if the block of residual video data is to be encoded losslessly, then encode the block of residual video data according to the lossless coding mode, to form an encoded block of residual video data, where encoding the block of residual video data comprises bypassing quantization and sign hiding during encoding the block of residual video data, and bypassing all loop filters with respect to a reconstructed block of video data that is based on the encoded block of residual video data.

In this manner, video decoder 30 may be an example of a video decoder configured to determine whether an encoded block of residual video data was encoded losslessly in accordance with a lossless coding mode, based on whether transform operations were skipped during encoding of the block of residual video data, and if the block of residual video data was encoded losslessly, then decode the encoded block of residual video data according to the lossless coding mode to form a reconstructed block of residual video data, where decoding the encoded block of residual data comprises bypassing quantization and sign hiding while decoding the encoded block of residual video data, and bypassing all loop filters with respect to the reconstructed block of residual video data.

In this manner, one or both of video encoder 20 and video decoder 30 may be examples of a device configured to determine whether to code a block of residual video data losslessly in accordance with a lossless coding mode, based on whether transform operations are skipped during coding of the block of residual video data, and if the block of residual video data is to be coded losslessly, then code the block of residual video data according to the lossless coding mode to form a reconstructed block of residual video data, where, to code the block of residual data, the device is configured to bypass quantization and sign hiding while coding the block of residual video data, and bypassing all loop filters with respect to the reconstructed block of residual video data.

Moreover, source device 12 and/or destination device 14 may be examples of a device for coding video data, the device including a video coder configured to determine a coding mode from a plurality of coding modes for coding a block of residual video data, wherein the plurality of coding modes includes at least one lossless coding mode, code the block of residual video data according to the determined coding mode, determine whether the coded block of residual video data was coded losslessly, and determine a quantization parameter (QP) associated with the coded block of residual video data based on the determination of whether the block of residual video data was coded losslessly.

In another example of the disclosure, video encoder 20 may signal the transform_skip_enabled_flag in the sequence parameter set (SPS), or at a lower level such as the picture parameter set (PPS) or slice header. If video encoder 20 determines that the transform_skip_enabled_flag is enabled (e.g., equal to 1 and if the ts_flag (transform_skip_flag) is equal to 1, then video encoder 20 may skip the transform for the residual (in general, this be any transform unit size and intra or inter mode).

Video encoder 20 may signal an additional flag to indicate whether the residual is losslessly represented (quantizer step size=1 is used; QP=4) or lossy. The additional flag is referred to herein as the transform_skip_lossless_flag and video encoder 20 may signal the transform_skip_lossless_flag at the SPS-level or at a lower level, such as PPS, slice header, LCU-level, group of CU-level, CU-level, or transform level. Video encoder 20 may determine the signaling of the transform_skip_lossless_flag to be dependent on a higher-level enable flag, such as transquant_bypass_enabled_flag, which may be signaled in the SPS, PPS, or at the slice-level, LCU-level or group of CU-level, or CU-level.

If the transform_skip_lossless_flag is equal to 1, then video encoder 20 may skip quantization for the residuals, which may be equivalent to using quantization step size equal to 1 or QP=4. In this case, video encoder 20 may assign the QP_{Y} value (predicted QPy,pre+optionally cu_delta_qp) to the losslessly coded block for use by a deblocking filter only for filtering the boundary of the lossless block on only one side or on both sides of the boundary (filtering on only the lossy boundary side may be preferred in this case; the deblocking filter may compute an average of the QP_{Y} values of the P an Q blocks on both sides of the edge between P and Q). Optionally, video encoder 20 may signal a cu_delta_qp for the quantization group containing the residual or cu_delta_qp can be inferred zero if not present. If video encoder 20 determines that the transform_skip_lossless_flag is equal to 0, then video encoder 20 may use the QP_{Y} and optional cu_delta_qp values as normal, e.g., by the quantization and the deblocking filter.

Video encoder 20 may signal an additional flag to indicate whether the loop filters (such as a deblocking filter, SAO filter, or ALF) are enabled or disabled with respect to the reconstructed samples. The signaled flag is referred to herein as the transform_skip_loopfilter_enabled_flag. If the transform_skip_loopfilter_enabled_flag is equal to one, then video encoder 20 may enable the loop filters with respect to the reconstructed samples. Otherwise, video encoder 20 may disable the loop filters (similar functionality as pcm_loopfilter_disable_flag). In examples, video encoder 20 may disable the loop filters if the residual was not quantized (quantizer step size=1) or, equivalently, represented losslessly. The transform_skip_loopfilter_enabled_flag can be signaled at the SPS level or at a lower level, such as PPS, slice header, group of CU-level, CU-level, or transform level. Table 1 below shows example syntax for this example.

TABLE 2

| residual_coding( x0, y0, log2TrafoWidth, | |
|---|---|
| log2TrafoHeight, scanIdx, cIdx ) | |
| { | Descriptor |
| If( transform_skip_enabled_flag && (PredMode == | |
| MODE_INTRA) && ( log2TrafoWidth == 2) && | |
| (log2TrafoHeight == 2) ) { | |
| transform_skip_flag[ x0 ][ y0 ][ cIdx ] | ae(v) |
| if ( transquant_bypass_enabled_flag ) | |
| transform_skip_lossless_flag[ x0 ] | ae(v) |
| [ y0 ][ cIdx] | |
| } | |
| .... | |

In another example, video encoder 20 may signal a transform_skip_enable_flag together with the transquant_bypass_enable_flag in the SPS, PPS, or slice header. Video encoder 20 may signal the transform_skip_enable_flag in a manner that is dependent on the transquant_bypass_enable_flag.

In this example, if transquant_bypass_enable_flag is equal to 1, then video encoder 20 may optionally bypass transforms and quantization (scaling) at a lower level such as the CU, unless the transform_skip_enable_flag is equal to 1. In the latter case, video encoder 20 may bypass quantization, additionally dependent on the cu_transform_skip_flag and the transform_skip_flag. Video encoder 20 may signal the cu_transform_skip_flag (inferred 0 if not present) together with the cu_transquant_bypass_flag, for example, at the CU level. In this example, if the transquant_bypass_enable_flag is equal to 1, video encoder 20 may signal the cu_transquant_bypass_flag at, for example, the CU level or at a higher level such as CTB (LCU) or slice or minimum CU group size. Additionally, in this example, if the transform_skip_enable_flag equals 1 and the cu_transquant_bypass_flag equals 1, then video encoder 20 may signal the cu_transform_skip_flag at the CU level or at a higher level such as CTB (LCU) or slice or minimum CU group size.

If video encoder 20 determines that the cu_transquant_bypass_flag equal to 1, video encoder 20 may bypass quantization and transforms for the CU (or CTB/LCU or slice or minimum CU group size), in this example, unless the transform_skip_enable_flag and the cu_transform_skip_flag are also equal to 1. In the latter case, video encoder 20 may signal the cu_transform_skip_flag if equal to 1. In other words, video encoder 20 may use transform skip within the CU, or equivalently, may skip only the transform and not the quantization process. In the latter case, video encoder 20 may signal the transform_skip_flag, for example, in the residual coding syntax, to indicate for 4×4 intra TUs (other TU sizes and inter mode are also possible) that the transform is skipped. By signaling the cu_skip_flag to control the signaling of the transform_skip_flag, video encoder 20 may save the signaling of transform_skip_flag bits in case, for example, the CU does not use transform skipping.

In examples, video encoder 20 may signal of the cu_transform_skip_flag dependent on the CU size. For example, video encoder 20 may signal the flag for CU sizes greater or smaller than a particular CU size, or signal the flag for one particular CU size. Video encoder 20 may signal the signaling of the cu_transform_skip_flag dependent on the mode of the CU, such as intra or inter. Additionally, video encoder 20 may signal this flag dependent on the partition type, such as 2N×2N or N×N.

Regarding the deblocking filter process, for example, if video encoder 20 determines the cu_transquant_bypass_flag to be equal to 1 and the cu_transform_skip_flag to be equal to 0, then video encoder 20 may use QP_{Y} only with respect to the deblocking filter (no filtering of lossless samples, including no SAO, ALF). Otherwise, video encoder 20 may use QP_{Y} with respect to the quantization process and the deblocking filter. Video encoder 20 may signal an additional flag to indicate whether the loop filters, such as deblocking, SAO, ALF, are enabled or disabled on the reconstructed samples. The additional flag is referred to herein as the transquant_loopfilter_enabled_flag. If the transquant_loopfilter_enabled_flag is equal to one, then video encoder 20 may enable the loop filters are enabled with respect to the reconstructed samples. Otherwise, video encoder 20 may disable the loop filters (similar functionality as pcm_loopfilter_disable_flag). In examples, video encoder 20 may disable the loop filters if the residual is not quantized (e.g., if the quantizer step size=1), or equivalently, is represented losslessly. Video encoder 20 may signal the transquant_loopfilter_enabled_flag at the SPS level or at a lower level, such as the PPS, slice header, group of CU-level, CU-level, or transform level.

Furthermore, for example, if video encoder 20 determines that the value of the cu_transform_skip_flag is equal to 1, then video encoder 20 may replace the transforms with a right shift operation. Regarding sign hiding in the residual coding syntax, the video encoder 20 may make the signHidden value dependent on both the cu_transquant_bypass_flag and the cu_transform_skip_flag. In this example, video encoder 20 may set the signHidden value equal to 0, if the cu_transquant_bypass_flag is equal to 1. Similarly, video encoder 20 may set the signHidden value equal to 1, if the cu_transquant_bypass_flag is equal to 1 and the cu_transform_skip_flag is equal to 1.

The syntax changes described above are contained in Tables 2-6.1.

TABLE 3
PPS

| ..... | Descriptor |
|---|---|
| transquant_bypass_enable_flag | u(1) |
| if (transquant_bypass_enable_flag) | |
| transform_skip_enable_flag | u(1) |
| Note: value inferred 0 is not present | |

TABLE 4
Coding unit syntax

| ...... | Descriptor |
|---|---|
| if( transquant_bypass_enable_flag ) { | |
| cu_transquant_bypass_flag | ae(v) |
| .... | |
| if ( PredMode == MODE_INTRA | |
| && transform_skip_enable_flag | |
| && cu_transquant_bypass_flag) | |
| cu_transform_skip_flag | ae(v) |
| } Note: value inferred 0 is not present | |
| ..... | |

TABLE 5
Residual coding syntax

| | Descriptor |
|---|---|
| residual_coding( x0, y0, log2TrafoWidth, log2TrafoHeight, | |
| scanIdx, cIdx ) | |
| { | |
| If( cu_transform_skip_flag && (PredMode == | |
| MODE_INTRA) && ( log2TrafoWidth == 2) | |
| && (log2TrafoHeight == 2) ) { | |
| transform_skip_flag[ x0 ][ y0 ][cIdx ] | ae(v) |
| } | |
| .... | |

TABLE 6.1
Sign hiding value in residual coding syntax

| | |
|---|---|
| ..... | Descriptor |

```
signHidden = ( lastNZPosInCG − firstNZPosInCG >=
sign_hiding_threshold &&
      ( !cu_transquant_bypass_flag ||
      cu_transform_skip_flag ) ) ? 1 : 0
      ......
```

In another example, video encoder 20 may signal a transform_skip_enable_flag together with the transquant_bypass_enable_flag in the SPS, PPS, or slice header. Video encoder 20 may optionally make the signaling of the transquant_bypass_enable_flag (if not present, then value 0 is inferred) dependent on the transform_skip_enable_flag, as skipping or bypassing the transform is shared between “lossless coding” and “transform skip” modes (e.g., as shown in Table 7). Alternatively, video encoder 20 may optionally make the signaling of the transform_skip_enable_flag (if not present, then value 0 is inferred) dependent on the transquant_bypass_enable_flag (e.g., as shown in Table 8 below).

In the example of Table 7, if transform_skip_enable_flag is equal to 1, then video encoder 20 may potentially bypass the transforms at a lower level such as the intra 4×4 TU, unless the transquant_bypass_enable_flag is equal to 1. In the example of Table 8, if transquant_bypass_enable_flag is equal to 1, then video encoder 20 may potentially bypass both the transforms and quantization at a lower level, unless the transform_skip_enable_flag is equal to 1. In both examples, video encoder 20 may bypass quantization, dependent additionally on the cu_transquant_bypass_flag.

In the example of Table 9, if the transform_skip_enable_flag equals 1, then video encoder 20 may signal the cu_transform_skip_flag (inferred 0 if not present) at the CU level, at a higher level such as CTB/LCU, or slice or at minimum CU group size (e.g. as in the previously described solution). In this example, cu_transform_skip_flag equal to 1 means that video encoder 20 may use transform skip within the CU, or equivalently, only the transform is skipped and not the quantization process. In the latter case, video encoder 20 may signal the transform_skip_flag, for example, in the residual coding syntax to indicate for 4×4 intra TUs (other TU sizes and inter mode are also possible) that the transform is skipped. By signaling the cu_transform_skip_flag to control the signaling of the transform_skip_flag, video encoder 20 may save the signaling of transform_skip_flag bits in case, for example, the CU does not use transform skipping. In addition, in this example, if transquant_bypass_enable_flag equals 1 and cu_transform_skip_flag equals 1, then the cu_transquant_bypass_flag may be signaled (inferred 0 if not present). The cu_transquant_bypass_flag equal to 1 means that both quantization and transforms are bypassed for the CU (or minimum CU group size or CTB/LCU or slice), which means that the CU is “losslessly coded”.

If the cu_transform_skip_flag is equal to 1 and the cu_transquant_bypass_flag is equal to 0, then video encoder 20 may signal the transform_skip_flag, for example in the residual coding syntax, to indicate for 4×4 intra TUs (other TU sizes and inter mode are also possible) that the transform is skipped (Table 9).

Regarding the deblocking filter process, for example, if cu_transquant_bypass_flag is equal to 1, then QP_{Y} is only used by the deblocking filter of video encoder 20 and/or video decoder 30, otherwise, QP_{Y} is used in the quantization process and by the deblocking filter. If cu_transquant_bypass_flag is equal to 1, the deblocking filtering, SAO and ALF are skipped on the lossless samples.

If transform_skip_flag is equal to 1, then the transforms may be replaced by a right shift. Regarding sign hiding in the residual coding syntax (Table 10), the signHidden value can be made dependent on both the cu_transquant_bypass_flag and the cu_transform_skip_flag. In this example, the signHidden value can be equal to 0, if the cu_transquant_bypass_flag is equal to 1, and the signHidden value can be equal to 1, if the cu_transquant_bypass_flag is equal to 0 and the cu_transform_skip_flag is equal to 1.

In examples, the cu_transform_skip_flag and cu_transquant_bypass_flag may represent some coding efficiency loss compared to not signaling anything. To limit this efficiency loss, video encoder 20 may signal the flags at a higher level such as at the CTB/LCU level or at the slice level, or at a larger CU size, for example, by defining a minimum CU group size, e.g., as described above.

The syntax changes described above are included in Tables 6.2-10.

TABLE 6.2
PPS

| ...... | Descriptor |
|---|---|
| transform_skip_enable_flag | u(1) |
| if (transform_skip_enable_flag) | |
| transquant_bypass_enable_flag | u(1) |
| Note: value inferred 0 is not | |
| present | |

TABLE 7
PPS alternative

| ...... | Descriptor |
|---|---|
| transquant_bypass_enable_flag | u(1) |
| if (transquant_bypass_enable_flag) | |
| transform_skip_enable_flag | u(1) |
| Note: value inferred 0 is not | |
| present | |

TABLE 8
Coding unit syntax

| | |
|---|---|
| if( transform_skip_enable_flag ) { | |
| cu_transform_skip_flag | ae(v) |
| if (transquant_bypass_enable_flag && | |
| cu_transform_skip_flag) | |
| cu_transquant_bypass_flag | ae(v) |
| } Note: value inferred 0 is not present | |
| ..... | |

TABLE 9
Residual coding syntax

| residual_coding( x0, y0, log2TrafoWidth, | |
|---|---|
| log2TrafoHeight, scanIdx, cIdx ) | |
| { | Descriptor |
| If( cu_transform_skip_flag && | |
| !cu_transquant_bypass_flag && | |
| (PredMode == MODE_INTRA) && | |
| ( log2TrafoWidth == 2) && | |
| (log2TrafoHeight == 2) ) { | |
| transform_skip_flag[ x0 ][ y0 ][ cIdx ] | ae(v) |
| } Note: value inferred 0 if not present | |
| .... | |

TABLE 10
Sign hiding value in residual coding syntax

| ..... | Descriptor |
|---|---|
| signHidden = ( lastNZPosInCG − firstNZPosInCG >= | |
| sign_hiding_threshold && | |
| ( cu_transform_skip_flag \|\| | |
| !cu_transquant_bypass_flag ) ) ? 1 : 0 | |
| ...... | |

In another example, video encoder 20 may effectively make the transform skip mode lossless by setting QP′_{Y} equal to 4 or, equivalently, the quantizer step size equal to 1. Additionally, loop filters (deblocking, SAO and ALF) of video encoder 20 and/or video decoder 30 may be configured so that the lossless samples remain unmodified. In examples, the signaling of cu_qp_delta may not be allowed if the coded block flags (cbf) of both luma and chroma are zero. Equivalently, in the lossless case (transform is skipped and quantization with step size 1) this means that the residual is equal to zero. In the latter case, it may not be guaranteed that the QP value can be set equal to 4 and, therefore, lossless coding may not be guaranteed.

Video encoder 20 may make the signaling of cu_delta_qp additionally dependent on a particular prediction mode, so that video encoder 20 may fall back on this mode for signaling cu_delta_qp in the lossless coding case if the residual is equal to zero. The fallback mode (fallback_mode) can be of the intra or inter type (MODE_INTRA or MODE_INTER). In case of intra, the fallback mode can be a particular directional or non-directional (DC, planar) prediction mode corresponding with a particular unit size (W×H), such as a transform unit (for example 4×4).

The usage of the fallback mode to signal cu_delta_qp may be dependent on a flag that is signaled by video encoder 20 at any syntax level such as the SPS, PPS, slice level, CU level, or below. Examples are the cu_transquant_bypass_flag or cu_transform_skip_flag described above. Tables 11-12 include further details on this implementation. Video encoder 20 may signal these flags at a higher level than the CU level, such as for a minimum CU group size, as described in previous solutions.

TABLE 11
Using fallback mode to force signaling of cu_qp_delta.

| transform_unit( x0L, y0L, x0C, y0C, log2TrafoWidth, log2TrafoHeight, trafoDepth, blkIdx ) { | Descriptor |
|---|---|
| if( cbf_luma[ x0L ][ y0L ][ trafoDepth ] \| \| cbf_cb[ x0C ][ y0C ][ trafoDepth ] \| \| | |
| cbf_cr[ x0C ][ y0C ][ trafoDepth ] | |
| \| \| (cu_transquant_bypass_flag && PredMode == MODE_INTRA && log2TradoWidth == W | |
| && log2TrafoHeight == H && IntraPredMode == fallback_mode) { | |
| if( (max_cu_qp_delta_depth > 0) && !IsCuQpDeltaCoded ) { | |
| cu_qp_delta | ae(v) |
| IsCuQpDeltaCoded = 1 | |
| } | |
| } | |
| if( cbf_luma[ x0L ][ y0L ][ trafoDepth ] \|\| cbf_cb[ x0C ][ y0C ][ trafoDepth ] \|\| | |
| cbf_cr[ x0C ][ y0C ][ trafoDepth ] { | |
| log2TrafoSize = ( ( log2TrafoWidth + log2TrafoHeight ) >> 1 ) | |
| .... | |

TABLE 12
Using fallback mode to force signaling of cu_qp_delta.

| transform_unit( x0L, y0L, x0C, y0C, log2TrafoWidth, log2TrafoHeight, trafoDepth, bl | |
|---|---|
| kIdx ) { | Descriptor |
| if( cbf_luma[ x0L ][ y0L ][ trafoDepth ] \| \| cbf_cb[ x0C ][ y0C ][ trafoDepth ] \| \| | |
| cbf_cr[ x0C ][ y0C ][ trafoDepth ] | |
| \| \| (cu_transform_skip_flag && PredMode == MODE && log2TradoWidth == W && | |
| log2TrafoHeight == H && IntraPredMode == fallback_mode) { | |
| if( (max_cu_qp_delta_depth > 0) && !IsCuQpDeltaCoded ) { | |
| cu_qp_delta | ae(v) |
| IsCuQpDeltaCoded = 1 | |
| } | |
| } | |
| if( cbf_luma[ x0L ][ y0L ][ trafoDepth ] \| \| cbf_cb[ x0C ][ y0C ][ trafoDepth ] \| \| | |
| cbf_cr[ x0C ][ y0C ][ trafoDepth ] { | |
| log2TrafoSize = ( ( log2TrafoWidth + log2TrafoHeight ) >> 1 ) | |
| .... | |

In another example, video encoder 20 may make the signaling of cu_qp_delta dependent on a flag indicating that transforms and/or quantization are bypassed. Video encoder 20 may signal such a flag in the SPS or PPS, or at the slice, CU or minimum CU group level. Examples are the transquant_bypass_enable_flag, transform_skip_enable_flag, cu_transquant_bypass_flag, or cu_transform_skip_flag that are described above.

If such a flag is enabled, video encoder 20 may enforce the signaling of cu_delta_qp at the beginning of, for example, the CU or minimum CU group size. In examples, the cu_transquant_bypass_flag and/or cu_transform_skip_flag, employed in implementations described above, may represent some coding efficiency loss compared to not signaling anything. To limit such efficiency loss, video encoder 20 may signal one or both flags at a higher level, such as at the CTB/LCU level the slice level, or at a larger CU size than the smallest CU size, for example, by defining a minimum CU group size.

Video encoder 20 may define a minimum CU group size by signaling a parameter in the SPS, PPS, or the slice header, such as Log₂ MinCUgroupSize (or Log 2 MinCUTransformSkipSize), which directly defines the minimum CU group size (log 2). Alternatively, analogous to Log 2 MinCUDQPSize, the parameter diff_cu_bypass_depth (or diff_cu_transform_skip_depth) may be signaled. The value of this parameter may be in the range of 0 to (log 2_diff_max_min_coding_block_size), inclusive.

In this example, one of the following equations may be used to compute the minimum CU group size (Log₂ MinCUgroupSize or Log 2 MinCUTransformSkipSize):

Log₂ MinCUgroupSize=Log₂ MaxCUSize−diff_cu_bypass_depth, when the value of diff_cu_bypass_depth>=0.
with diff_cu_bypass_depth>=0

Log₂ MinCUgroupSize=Log₂ MaxCUSize−(diff_cu_bypass_depth−1)
with diff_cu_bypass_depth>=1 and value 0 may be used to disable transform and/or quantization bypass (skip) entirely. In this case, signaling and checking of the transquant_bypass_enable_flag or the transform_skip_enable_flag is optional in these examples.
   The value of Log₂ MinCUgroupSize (or Log 2 MinCUTransformSkipSize) can be set equal to the value of Log 2 MinCUDQPSize, or equivalently, the value of Log 2 MinCUDQPSize may be used to also specify the minimum CU group size in this implementation (in addition to the minimum CU quantization group size). Tables 13-15 demonstrate the syntax changes based on the above example.

TABLE 13
PPS level signaling of diff_cu_bypass_depth and/or
diff_cu_transform_skip_depth

| | |
|---|---|
| pic_parameter_set_rbsp( ) { | Descriptor |

| | |
|---|---|
| ..... | |
| slice_granularity | u(2) |
| diff_cu_qp_delta_depth | ue(v) |
| if ( transquant_bypass_enable_flag) | |
| diff_cu_transquant_bypass_depth | ue(v) |
| if (transform_skip_enable_flag) | |
| diff_cu_transform_skip_depth | ue(v) |
| .... | |

TABLE 14
Coding tree syntax for diff_cu_transquant_bypass_depth (in
this example) or diff_cu_transform_skip_depth

```
coding_tree( x0, y0, log2CbSize, ctDepth ) {
  . . .
  if( ( diff_cu_qp_delta_depth > 0 ) && log2CbSize >=
  Log2MinCUDQPSize )
    IsCuQpDeltaCoded = 0
  if( transquant_bypass_enable_flag &&
  diff_cu_transquant_bypass_depth > 0
    && log2CbSize >= Log2MinCUTransquantSize )
    IsCuTransquantBypassCoded = 0
  . . .
```

TABLE 15
Coding unit syntax for diff_cu_transquant_bypass_depth (in
this example) or diff_cu_transform_skip_depth

| coding_unit( x0, y0, log2CbSize ) { | Descriptor |
|---|---|
| . . . | |
| if( transquant_bypass_enable_flag && | |
| diff_cu_transquant_bypass_depth > 0 && | |
| !IsCuTransquantBypassCoded) { | |
| cu_transquant_bypass_flag | ae(v) |
| IsCuTransquantBypassCoded = 1 | |
| } | |
| . . . | |

In another example, video encoder 20 may use the parameters that specify the IPCM block_size to specify the minimum CU group size for signaling cu_transquant_bypass_flag or cu_transform_skip_flag. Table 16 specifies the relevant IPCM parameters, followed by the semantics. Alternatively, video encoder 20 may signal these parameters in the PPS or slice header.

TABLE 16
SPS parameters specifying allowed IPCM block sizes

| seq_parameter_set_rbsp( ) { | Descriptor |
|---|---|
| . . . | |
| if( pcm_enabled_flag \|\| transquant_bypass_enable_flag \|\| | |
| transform_skip_enable_flag) { | |
| log2_min_pcm_coding_block_size_minus3 | ue(v) |
| log2_diff_max_min_pcm_coding_block_size | ue(v) |
| } | |
| . . . | |

The syntax element log 2_min_pcm_coding_block_size_minus3+3 specifies the minimum size of I_PCM coding blocks. The variable Log 2 MinIPCMCUSize is set equal to log 2_min_pcm_coding_block_size_minus3+3. The variable Log 2 MinIPCMCUSize shall be equal or less than Min(Log 2CtbSize, 5).

The syntax element log 2_diff_max_min_pcm_coding_block_size specifies the difference between the maximum and minimum size of I_PCM coding blocks. The variable Log 2 MaxIPCMCUSize is set equal to log 2_min_pcm_coding_block_size_minus3+3+log 2_diff_max_min_pcm_coding_block_size. The variable Log 2 MaxIPCMCUSize shall be equal or less than Min(Log 2CtbSize, 5).

TABLE 17
Coding tree syntax for cu_transquant_bypass_flag (in this
example) or cu_transform_skip_flag

```
coding_tree( x0, y0, log2CbSize, ctDepth ) {
  . . .
  if( ( diff_cu_qp_delta_depth > 0) && log2CbSize >=
  Log2MinCUDQPSize )
    IsCuQpDeltaCoded = 0
  if( transquant_bypass_enable_flag && log2CbSize >=
Log2MinIPCMCUSize)
    IsCuTransquantBypassCoded = 0
  . . .
```

TABLE 18
Coding unit syntax for cu_transquant_bypass_flag (in this
example) or cu_transform_skip_flag

| coding_unit( x0, y0, log2CbSize ) { | Descriptor |
|---|---|
| . . . | |
| if( transquant_bypass_enable_flag && | |
| !IsCuTransquantBypassCoded) | |
| { | |
| cu_transquant_bypass_flag | ae(v) |
| IsCuTransquantBypassCoded = 1 | |
| } | |
| . . . | |

In WD7 of HEVC, the transform_skip_enabled_flag is signaled in the SPS. If transform skip is enabled and if the transform_skip_flag in the residual coding syntax is equal to 1, some proposals for HEVC specify that the transform is skipped for a 4×4 intra TU (see WD7) or potentially for an inter TU. Transform skipping for an inter TU has been proposed in A. Gabriellini, M. Mrak, D. Flynn, M. Naccari, “Transform Skipping for Inter Predicted Coding Units,” 10^{th} JCT-VC Meeting, Stockholm, Sweden, July 2012, Doc. JCTVC-J0077 (hereinafter, “J0077), C. Lan, J. Xu, D. He, X. Yu, “Lossless coding via transform skipping,” 10^{th} JCT-VC Meeting, Stockholm, Sweden, July 2012, Doc. JCTVC-J0238 (hereinafter, “J0238”), and X. Peng, C. Lan, J. Xu, G. J. Sullivan, “Inter transform skipping,” 10th JCT-VC Meeting, Stockholm, Sweden, July 2012, Doc. JCTVC-J0237 (hereinafter; “J0237”).

J0238 proposes to use the transform skip mode together with a QP_{Y} value equal to 4 (which corresponds with quantization step size 1), to support lossless coding and replace the “TransQuantBypass” mode of WD7. The “TransQuantBypass” mode, which bypasses transform, quantization, sign hiding, loop filtering, is enabled at the PPS level through the transquant_bypass_enabled_flag and the cu_transquant_bypass_flag at the CU level. The “TransQuantBypass” mode based on signaling solves the issue that exists with signaling of cu_qp_delta values for setting the QP_{Y} value equal to 0 for enabling lossless coding. The problem is that cu_qp_delta cannot be signaled if the residual is zero. However, the same problem exists in J0238, which proposes to use a QP_{Y} value equal to 4, which is also achieved by signaling cu_qp_delta. Secondly, J0238 claims that the deblocking filter is disabled on the lossless samples if the QP_{Y} value is equal to 4. However, this cannot be guaranteed if the QP_{Y} of a neighboring coding unit is large enough so that the average QP, which is used to set the deblocking strength, is larger than a value of 17.

In view of these drawbacks, this disclosure presents additional techniques that build upon on the example described above relating to Table 1. To mitigate the above-discussed problems, this disclosure proposes an implementation by which video encoder 20 may signal a flag to indicate whether quantization is bypassed in addition to skipping the transform. Video encoder 20 may signal this “transform_skip_lossless_flag” for a group of CUs, similar to a minimum CU quantization group described above with reference to Tables 13-18 and in W. Gao, M. Jiang, H. Yu, “AHG11: New signalling mechanism for lossless coding,” 10^{th} JCT-VC Meeting, Stockholm, Sweden, July 2012, Doc. JCTVC-J0340 (hereinafter, “J0340”). In another example, video encoder 20 may define a minimum and maximum CU size similar to IPCM, as described above with reference to Tables 13-18 and in E. Francois, P. Onno, G. Laroche, T. Poirier, M. Shima, “AHG11: Syntax harmonisation of the I_PCM and TransQuantBypass modes,” 10th JCT-VC Meeting, Stockholm, Sweden, July 2012, Doc. JCTVC-J0168 (hereinafter “J0168’). As an alternative name for the “transform_skip_lossless_flag”, the cu_transquant_bypass_flag name may be reused from WD7.

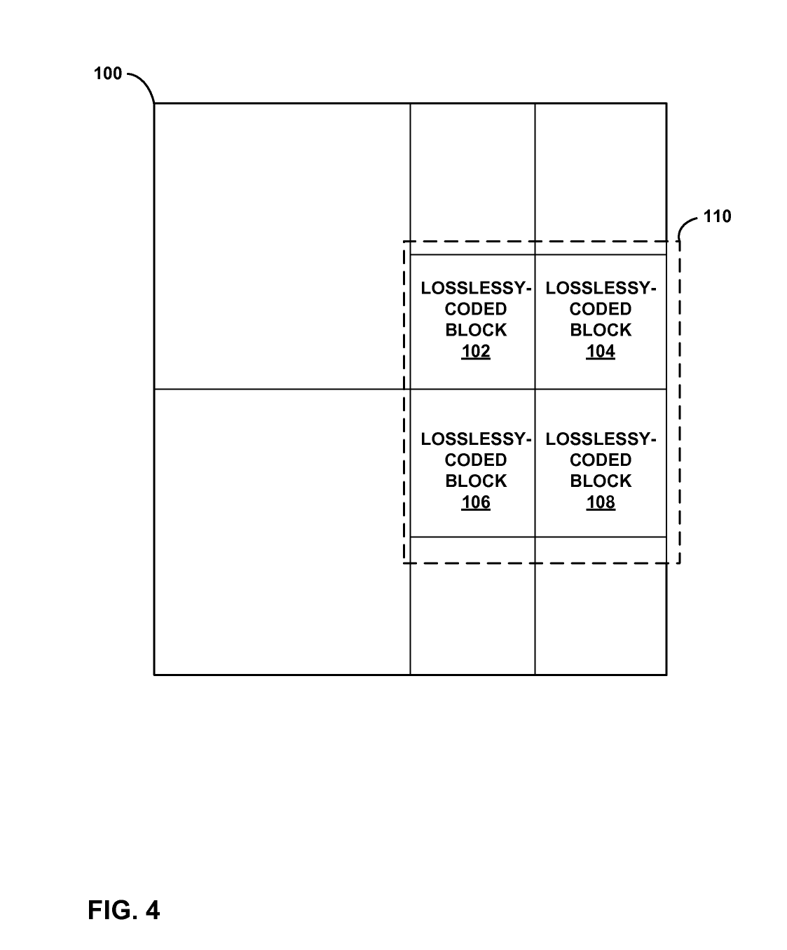

Video encoder 20 may make the signaling of the transform_skip_lossless_flag (cu_transquant_bypass_flag) dependent on a higher-level enable flag, such as transquant_bypass_enabled_flag, which is signaled in the PPS, or alternatively in the SPS or slice header. If the transform_skip_lossless_flag (cu_transquant_bypass_flag) is equal to 1 for a coding unit or group of coding units, then the quantization, sign hiding and loop filtering (deblocking, SAO, ALF) are bypassed in addition to the transform for the 4×4 intra or inter TUs with transform_skip_flag equal to 1 (applies in general to other allowed TU sizes). In this case, the QP_{Y} value (predicted QPy, pred+optionally cu_delta_qp) is assigned to the lossless blocks for use by the deblocking filter only for filtering the boundary of the lossless block on the lossy side of the boundary (cfr. IPCM blocks and lossless “TransQuantBypass” mode blocks of WD7). In case the transform_skip_lossless_flag (cu_transquant_bypass_flag) is equal to 0, then the QP_{Y} and optional cu_delta_qp values may be used as normal by one or both of video encoder 20 and video decoder 30, more specifically, by the respective quantization (or inverse quantization) unit, and the deblocking filter. FIG. 4 illustrates this concept. As described below with respect to FIG. 4, “ts_lossless”=“transform_skip_lossless_flag” and “ts_flag”=transform_skip_flag.

Signaling examples for the transform_skip_lossless_flag (cu_transquant_bypass_flag) based on the minimum CU group concept are illustrated sizes are illustrated above with reference to Tables 13-1 8 and in J0340. Alternative signaling examples that video encoder 20 may use, based on allowed IPCM block sizes are illustrated above with reference to Tables 13-18 and in J0168.

The following Tables 19-21 illustrate syntax alternatives for signaling, by video encoder 20, of the transform_skip_flag (including both intra and inter blocks).

TABLE 19
Transform skip flag syntax based on J0237 with changes
in bold text

| residual_coding( x0, y0, log2TrafoWidth, log2TrafoHeight, | |
|---|---|
| scanIdx, cIdx) { | Descriptor |
| if( log2TrafoWidth = = 1 \|\| log2TrafoHeight = = 1 ) { | |
| log2TrafoWidth = 2 | |
| log2TrafoHeight = 2 | |
| } | |
| If( transform_skip_enabled_flag && | |
| [symbol] | |
| && | |
| ( log2TrafoWidth = = 2) && | |
| (log2TrafoHeight = = 2) ) | |
| transform_skip_flag[ x0 ][ y0 ][ cIdx ] | ae(v) |
| . . . | . . . |

TABLE 20
Transform skip flag syntax based on J0077 with changes
in bold text

| residual_coding( x0, y0, log2TrafoWidth, log2TrafoHeight, | |
|---|---|
| scanIdx, cId x ) { | Descriptor |
| if( log2TrafoWidth = = 1 \|\| log2TrafoHeight = = 1 ) { | |
| log2TrafoWidth = 2 | |
| log2TrafoHeight = 2 | |
| } | |
| If( transform_skip_enabled_flag && | |
| [symbol] | |
| && | |
| (PredMode = = MODE_INTRA) && | |
| ( log2TrafoWidth = = 2) && (log2TrafoHeight = = 2) ) | |
| transform_skip_flag[ x0 ][ y0 ][ cIdx ] | ae(v) |
| else if( transform_skip_enabled_flag && | |
| [symbol] && | |
| ( PredMode != MODE_INTRA ) && ( cIdx = = 0) && | |
| ( log2TrafoWidth = = 2 ) && | |
| ( log2TrafoHeight = = 2 ) ) | |
| inter_transform_skip_flag[ x0 ][ y0 ] | ae(v) |
| last_significant_coeff_x_prefix | ae(v) |
| last_significant_coeff_y_prefix | ae(v) |
| if( last_significant_coeff_x_prefix > 3 ) | |
| last_signiflcant_coeff_x_suffix | ae(v) |
| . . . | |

TABLE 21
Alternative transform skip syntax based on J0077, J0237 and US
Provisional Application 61/663,453 with changes in bold text

| residual_coding( x0, y0, log2TrafoWidth, log2TrafoHeight, | |
|---|---|
| scanIdx, cIdx) { | Descriptor |
| if( log2TrafoWidth = = 1 \|\| log2TrafoHeight = = 1 ) { | |
| log2TrafoWidth = 2 | |
| log2TrafoHeight = 2 | |
| } | |
| If( transform_skip_enabled_flag && | |
| [symbol] | |
| && ( cIdx = = 0 ) && ( log2TrafoWidth = = | |
| 2) && (log2TrafoHeight = = 2) ) | |
| transform_skip_flag[ x0 ][ y0 ][ cIdx ] | ae(v) |
| . . . | . . . |

Further descriptions may be found in J0077, J0238, J0340, J0168, J0237 and U.S. Provisional Application 61/663,453. Typically, an encoder may not signal the transform_skip_flag if the coded block flag (cbf) is equal to 0 for the 4×4 TU. In that case, the encoder may apply all loop filtering, and the 4×4 block will not be lossless. Therefore, this disclosure includes techniques by which video encoder 20 may be configured to enforce the signaling of the transform_skip_flag for 4×4 TUs if the transform_skip_lossless_flag (cu_transquant_bypass_flag) is equal to 1 for the coding unit containing the 4×4 TUs. An example of the syntax is described in the following description.

As an alternative technique to video encoder 20 enforcing the signaling of the transform_skip_flag, video encoder 20 may implement techniques of this disclosure such that only 4×4 TUs are allowed within a lossless CU (transform_skip_lossless_flag is equal to 1) and that the transform_skip_flag value of each 4×4 TU equals 1. If the transform_skip_flag is not present, then video encoder 20 and/or video decoder 30 may infer the transform_skip_flag value to be equal to 1.

As one example alternative to the techniques described above with reference to Tables 19-21, techniques of this disclosure may build upon the techniques of J0238 and address the problem that cu_delta_qp is not signaled if the residual is 0. In this example, video encoder 20 may define a slice_transquant_bypass_flag signal the slice_transquant_bypass_flag in the slice header. If the slice_transquant_bypass_flag value is equal to 1, then within the slice, video encoder 20 and/or video decoder 30 may bypass all loop filters (deblocking, SAO, ALF) on samples of the 4×4 TUs with transform_skip_flag equal to 1 within the quantization group that has QP_{Y} value equal to 4 (quantization step size equal to 1). In addition, as described above with regard to signaling the cu_qp_delta, if the slice_transquant_bypass_flag is equal to 1, then video encoder 20 may signal the cu_delta_qp at the beginning of the CU or minimum CU group size.

As another alternative example, similar to the techniques described above with reference to Tables 19-21, if the slice_transquant_bypass_flag is equal to 1 and if QP_{Y} value is equal to 4, then video encoder 20 may enforce signaling of the transform_skip_flag for 4×4 TUs even if the coded block flag is equal to 0. Alternatively, if the slice_transquant_bypass_flag is equal to 1, video encoder 20 may enforce that only 4×4 TUs are allowed within a CU that has QP_{Y} value equal to 4 and that the transform_skip_flag value of each 4×4 TU is equal to 1. If the transform_skip_flag is not present, then video encoder 20 and/or video decoder 30 may infer the transform_skip_flag value to be equal to 1.

Tables 22-28 below show example syntax elements for signaling the slice_transquant_bypass_flag. Changes to the syntax are shown in bold.

TABLE 22

| slice_header( ) { | Descriptor |
|---|---|
| . . . | |
| slice_transquant_bypass_flag | u(1) |
| byte_alignment( ) | |
| } | |

TABLE 23

| coding_tree( x0, y0, log2CbSize, ctDepth ) { | Descriptor |
|---|---|
| . . . | |
| if( ( diff_cu_qp_delta_depth > 0 ) && | |
| log2CbSize >= Log2MinCUDQPSize ) | |
| { | |
| IsCuQpDeltaCoded = 0 | |
| IsQPY4 = 0 | |
| } | |
| . . . | |
| coding_unit( x0, y0, log2CbSize ) { | Descriptor |
| CurrCbAddrTS = MinCbAddrZS[ x0 >> | |
| Log2MinCbSize ][ y0 >> Log2MinCbSize ] | |
| [symbol] | |
| [symbol] | [symbol] |
| [symbol] | |
| if(slice_transquant_bypass_flag && | |
| ( diff_cu_qp_delta_depth > 0 ) | |
| && !IsCuQpDeltaCoded) | |
| { | |
| cu_qp_delta | ae(v) |
| IsCuQpDeltaCoded = 1 | |
| if (QP′_{Y} == 4) | |
| IsQPY4 = 1 | |
| } | |
| . . . | |

TABLE 24

| transform_tree( x0L, y0L, | |
|---|---|
| x0C, y0C, xBase, yBase, log2CbSize, log2TrafoWidth, log2TrafoHeight, | |
| trafoDepth, blkIdx ) { | Descriptor |
| . . . | |
| transform_tree( x0L, y0L, x0C, y0C, x0L, y0L, log2CbSize, | |
| log2TrafoWidth − 1, log2TrafoHeight − 1, trafoDepth + 1, 0 ) | |
| transform_tree( x1L, y1L, x1C, y1C, x0L, y0L, log2CbSize, | |
| log2TrafoWidth − 1, log2TrafoHeight − 1, trafoDepth + 1, 1 ) | |
| transform_tree( x2L, y2L, x2C, y2C, x0L, y0L, log2CbSize, | |
| log2TrafoWidth − 1, log2TrafoHeight − 1, trafoDepth + 1, 2 ) | |
| transform_tree( x3L, y3L, x3C, y3C, x0L, y0L, log2CbSize, | |
| log2TrafoWidth − 1, log2TrafoHeight − 1, trafoDepth + 1, 3 ) | |
| } else { | |
| if( PredMode = = MODE_INTRA \|\| trafoDepth != 0 \|\| | |
| cbf_cb[ x0 ][ y0 ][ trafoDepth ] \|\| | |
| cbf_cr[ x0 ][ y0 ][ trafoDepth ] ) | |
| cbf_luma[ x0L ][ y0L ][ trafoDepth ] | ae(v) |
| if( transform_skip_enabled_flag && (PredMode = = | |
| MODE_INTRA) && IsQPY4) | |
| { | |
| if ( log2TrafoWidth = = 2) && (log2TrafoHeight = = 2) | |
| { | |
| transform_skip_flag[ x0L ][ y0L ][ 0 ] | ae(v) |
| if (blkIdx == 3) | |
| { | |
| transform_skip_flag[ x0C ][ y0C ][ 1 ] | ae(v) |
| transform_skip_flag[ x0C ][ y0C ][ 2 ] | ae(v) |
| } | |
| } else if ( log2TrafoWidth = = 3) && (log2TrafoHeight = = 3) | |
| { | |
| transform_skip_flag[ x0C ][ y0C ][ 1 ] | ae(v) |
| transform_skip_flag[ x0C ][ y0C ][ 2 ] | ae(v) |
| } | |
| } | |
| transform_unit (x0L, y0L, x0C, | |
| y0C, log2TrafoWidth, log2TrafoHeight, trafoDepth, blkIdx) | |
| } | |
| } | |

If transform skip is enabled from inter 4×4 blocks as well, then the line if (transform_skip_enabled_flag && (PredMode==MODE_INTRA) && IsQPY4) in Table 24 may be replaced by if(transform_skip_enabled_flag && IsQPY4).

TABLE 25

| residual_coding( x0, y0, log2TrafoWidth, log2TrafoHeight, | |
|---|---|
| scanIdx, cIdx) { | Descriptor |
| if( log2TrafoWidth = = 1 \|\| log2TrafoHeight = = 1 ) { | |
| log2TrafoWidth = 2 | |
| log2TrafoHeight = 2 | |
| } | |
| If( transform_skip_enabled_flag && | |
| [symbol] && | |
| (PredMode = = MODE_INTRA) && !IsQPY4 && | |
| ( log2TrafoWidth = = 2) && (log2TrafoHeight = = 2) ) | |
| transform_skip_flag[ x0 ][ y0 ][ cIdx ] | ae(v) |
| . . . | |

If transform skip is enabled from inter 4×4 blocks as well, then the Table 25 is replaced by Table 26 below.

TABLE 26

| residual_coding( x0, y0, log2TrafoWidth, log2TrafoHeight, | |
|---|---|
| scanIdx, cIdx ) { | Descriptor |
| if( log2TrafoWidth = = 1 \|\| log2TrafoHeight = = 1 ) { | |
| log2TrafoWidth = 2 | |
| log2TrafoHeight = 2 | |
| } | |
| If( transform_skip_enabled_flag && | |
| [symbol] | |
| [symbol] | |
| [symbol] !IsQPY4 && | |
| ( log2TrafoWidth = = 2) && (log2TrafoHeight = = 2) ) | |
| transform_skip_flag[ x0 ][ y0 ][ cIdx ] | ae(v) |
| . . . | |

In some examples, instead of sending separate flag for luma and chroma components for 4×4 transform skip, video encoder 20 may signal a single flag that is applicable to luma and corresponding chroma blocks. In such instances, the syntax tables corresponding to transform_tree( ) and residual_coding( ) may be modified as follows:

TABLE 27

| transform_tree( x0L, y0L, | |
|---|---|
| x0C, y0C, xBase, yBase, log2CbSize, log2TrafoWidth, log2TrafoHeight, | |
| trafoDepth, blkIdx ) { | Descriptor |
| . . . | |
| transform_tree( x0L, y0L, x0C, y0C, x0L, y0L, log2CbSize, | |
| log2TrafoWidth − 1, log2TrafoHeight − 1, trafoDepth + 1, 0 ) | |
| transform_tree( x1L, y1L, x1C, y1C, x0L, y0L, log2CbSize, | |
| log2TrafoWidth − 1, log2TrafoHeight − 1, trafoDepth + 1, 1 ) | |
| transform_tree( x2L, y2L, x2C, y2C, x0L, y0L, log2CbSize, | |
| log2TrafoWidth − 1, log2TrafoHeight − 1, trafoDepth + 1, 2 ) | |
| transform_tree( x3L, y3L, x3C, y3C, x0L, y0L, log2CbSize, | |
| log2TrafoWidth − 1, log2TrafoHeight − 1, trafoDepth + 1, 3 ) | |
| } else { | |
| if( PredMode = = MODE_INTRA \|\| trafoDepth != 0 \|\| | |
| cbf_cb[ x0 ][ y0 ][ trafoDepth ] \|\| | |
| cbf_cr[ x0 ][ y0 ][ trafoDepth ]) | |
| cbf_luma[ x0L ][ y0L ][ trafoDepth ] | ae(v) |
| if( transform_skip_enabled_flag && (PredMode = = | |
| MODE_INTRA) && IsQPY4 && | |
| ( log2TrafoWidth = = 2) && (log2TrafoHeight = = 2)) | |
| { | |
| transform_skip_flag[ x0L ][ y0L ] | ae(v) |
| } | |
| transform_unit (x0L, y0L, x0C, | |
| y0C, log2TrafoWidth, log2TrafoHeight, trafoDepth, blkIdx) | |
| } | |
| } | |

TABLE 28

| residual_coding( x0, y0, log2TrafoWidth, log2TrafoHeight, | |
|---|---|
| scanIdx, cIdx) { | Descriptor |
| if( log2TrafoWidth = = 1 \|\| log2TrafoHeight = = 1 ) { | |
| log2TrafoWidth = 2 | |
| log2TrafoHeight = 2 | |
| } | |
| If( transform_skip_enabled_flag && | |
| [symbol] && | |
| (PredMode = = MODE_INTRA) && !IsQPY4 && | |
| ( log2TrafoWidth = = 2) && (log2TrafoHeight = = 2) ) | |
| transform_skip_flag[ x0 ][ y0 ] | ae(v) |
| . . . | |

If inter skip is enabled, suitable modifications may be implemented as described in the examples above. In J0238, lossless mode is coupled with luma QP equal to 4. However, if the current block has zero residual, cu_qp_delta cannot be signaled, and if QP predictor is different from 4, then the decoder cannot reconstruct a lossless coded block. As a result, the encoder and decoder will not match. Also, the same problem exists if the QP predictor is 4 and the block has zero residual. Then transform_skip_flag is not signaled. In this case, the decoder cannot distinguish lossless and lossy modes. If the transform_skip_flag is not present it may be inferred to be, for example, zero, meaning lossless mode or transform bypassed is not applied.

As an alternative example technique for addressing this problem, video encoder 20 may implement an encoder restriction, thereby imposing bitstream conformance. For example, video encoder 20 may determine that bitstreams do not contain a lossless coded block, i.e., a block coded with enabled transform_skip_flag, if the block has zero residual and QP or QP predictor is equal to 4 (or any other number associated with a lossless mode).

Alternatively or additionally, video encoder 20 may impose a similar constraint when QP or QP predictor is different from 4 or any other number associated with a lossless mode. For example, video encoder 20 may determine that the bitstream does not contain transform bypassed blocks, i.e., blocks coded with enabled transform_skip_flag, if a block has a zero residual.

Conversely, as another example, video encoder 20 may determine that the bitstream shall not contain a lossy coded block, i.e., a block coded with disabled transform_skip_flag, if the block has zero residual, since lossless or transform bypassed mode might be applied in this case. Video encoder 20 may impose additional conditions on QP in the last example. For example, video encoder 20 may determine that QP or QP predictor might be equal to 4 or any other number associated with a lossless mode.

As yet another alternative example, both video encoder 20 and video decoder 30 may infer the transform_skip_flag. For example, if a block has zero residual and QP or QP predictor is equal to 4 or any other number associated with a lossless mode for this block, video encoder 20 and video decoder 30 may infer that the transform_skip_flag is enabled (e.g., equal to one). This means lossless mode will be applied at one or both of video encoder 20 and video decoder 30. In another example, if a block has zero residual and QP or QP predictor is different from 4 or any other number associated with a lossless mode for this block, then video encoder 20 and video decoder 30 may infer the transform_skip_flag to be disabled (e.g., equal to zero). This means that lossy mode will be applied at one or both of video encoder 20 and video decoder 30. Alternatively, video encoder 20 and video decoder 30 may infer the transform_skip_flag to be enabled (e.g., equal to one). This means that transform bypass mode is applied at one or both of video encoder 20 and video decoder 30.

In additionally to solving the above-mentioned problem, one advantage of the described restrictions is that, in accordance with the described restrictions, it might not be necessary to reduce a QP range as proposed in J0238 to be [4, 51]. With the proposed restrictions of this disclosure, the QP range can still be [0, 51], but lossless mode cannot be achieved by one or both of video encoder 20 and video decoder 30 if QP is not equal to 4 or any other number associated with a lossless mode. More specifically, only a transform will be bypassed in this case, and quantization and loop filters might be applied.

In another example of the disclosure, in inter mode, video encoder 20 may skip a block by sending a skip_flag value of 1. For such skipped blocks, video encoder 20 may enable a lossless coding mode as follows. Video encoder 20 may signal a transform skip flag per every CU before the skip_flag. In this case, video encoder 20 and/or video decoder 30 may enable a lossless mode with respect to the Merge skip inter mode, in addition. As another alternative example, video encoder 20 may signal the transform skip flag before skip_flag, only for the QP associated with lossless mode (e.g., QP equal to 4). Since Merge skip mode does not include a transform, this flag is necessary only to indicate lossless mode. Thus, the merge-skip mode will be lossless if luma QP is 4 and transform skip flag is 1. As yet another alternative example, video encoder 20 may additionally signal a transform skip flag after skip_lag for every QP or only for QPs associated with a lossless mode (e.g., QP equal to 4).

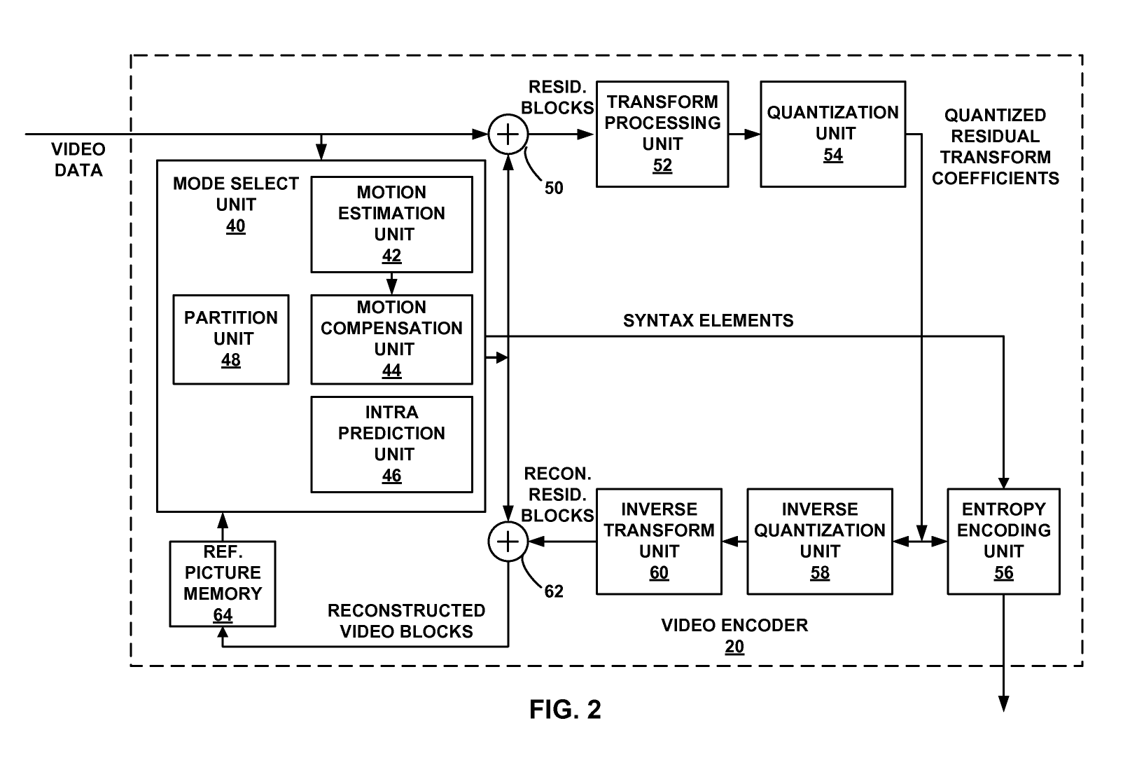

FIG. 2 is a block diagram illustrating an example of video encoder 20 that may implement techniques for signaling data for LTRPs in an SPS or slice header. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56. In various instances, mode select unit 40 may select either a lossless coding mode, such as transform skip mode or transquant bypass mode, according to which to encode a block of residual video data. Based on mode select unit 40 selecting a lossless coding mode with respect to a particular block of residual video data, and optionally, based on additional factors, other components of video encoder 20 may perform one or more techniques of this disclosure in encoding the block and/or in signaling data associated with the encoded block of residual video data. As one example, based on whether or not mode select unit 40 selects a lossless coding mode for a block of video data, transform processing unit 52 may determine whether or not to apply a transform to the residual block. Additionally or alternatively, quantization unit 54 may, based on the coding mode selected by mode select unit 40, determine whether or not to quantize the residual block.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma coding blocks, and motion compensation unit 44 uses motion vectors calculated based on the luma coding blocks for both chroma coding blocks and luma coding blocks. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

In one implementation of the techniques described herein, entropy encoding unit 56 may force the signaling of the cu_delta_qp syntax element, by causing mode select unit 40 to select a particular coding mode by which to encode the corresponding block of residual video. In other words, according to this implementation, entropy encoding unit 56 may ensure that the cu_delta_qp syntax element is signaled, based on a coding mode used to encode the corresponding block of residual video data. By ensuring that the cu_delta_qp is signaled in this way, entropy encoding unit 56 may mitigate or eliminate instances of the QP value not being signaled. In turn, by ensuring that the QP value is signaled, entropy encoding unit 56 may ensure that, if the QP value is set to four to indicate a non-quantized (and therefore, losslessly coded) block, then lossless coding is guaranteed by a device, such as a video decoder, that receives the encoded bitstream. The coding mode selected by mode select unit 40 to ensure signaling of the cu_delta_qp syntax element may also be referred to herein as a “fallback mode.” Mode select unit 40 may select either an intra-mode or an inter-mode as the fallback mode.

Additionally, entropy encoding unit 56 may signal an indication of the fallback mode according to which the block of residual video data was encoded, such as a flag, at any of syntax level, such as SPS, PPS, slice, CU level, or at a lower level still. In the case of the fallback mode being a lossless coding mode, entropy encoding unit 56 may signal a cu_transform_skip_flag or a cu_transquant_bypass_flag, to indicate the transform skip mode and the transquant bypass mode, respectively. Optionally, entropy encoding unit 56 may signal the indication of the fallback mode at a higher level than the CU level, such as for a CU group that satisfies a minimum group size in terms of a number of CUs.

According to another implementation of the techniques described herein, entropy encoding unit 56 may determine whether to signal the cu_delta_qp, depending on whether one or both of transform operations and quantization are performed for the block of residual video data. More specifically, according to this implementation, transform processing unit 52 may decline to perform any transform operations on the block if mode select unit 40 selects certain lossless coding modes, such as a transform skip mode or transquant bypass mode, with respect to the block. Additionally, if mode select unit 40 selects a lossless coding mode for the block, i.e. indicating that the encoded block is not to be quantized, quantization unit 54 may determine that the QP value for the block is four (or other value associated with lossless encoding and/or non-quantization). Additionally, entropy encoding unit 56 may signal an indication of the coding mode selected by mode select unit 40, such as the transquant_bypass_enable_flag, transform_skip_enable_flag, cu_transquant_bypass_flag, or cu_transform_skip_flag described above. Optionally, if encoding unit 56 signals one or more of the listed flags, entropy encoding unit 56 may signal (or enforce signaling) of the cu_delta_qp at the beginning of the CU corresponding to the block, or at the beginning of a CU group corresponding to the block, the CU group being determined based on a minimum group size.

According to yet another implementation of the techniques of this disclosure, entropy encoding unit 56 may associate an indication of encoding according to a lossless coding mode to a CU group associated with a block of residual video data. Entropy encoding unit 56 may determine the minimum size for a CU group through a variety of calculations, such as by executing one or more of the formulas described with respect to FIG. 1. In turn, entropy encoding unit 56 may signal one or both flags associated with the lossless coding mode at the beginning of a CU group that includes a particular block of residual video data that was encoded using a lossless coding mode. Additionally, entropy encoding unit 56 may signal the minimum CU group size as a parameter at the SPS or PPS level, or in a slice header.

Alternatively, under this implementation, entropy encoding unit 56 may use parameters that are traditionally used to specify an intra pulse code modulation (IPCM) block size, in order to signal a flag that indicates a lossless coding mode. More specifically, entropy encoding unit 56 may signal (e.g., at PPS level or in the slice header) particular IPCM parameters, followed by particular semantics. The combination of the selected IPCM parameters and the particular semantics may enable entropy encoding unit 56 to signal an indication of coding according to a lossless coding mode. Examples of such an indication include the cu_transform_skip_flag and the cu_transquant_bypass_flag.

In instances where entropy encoding unit 56 signals data for a block of residual data encoded according to transquant bypass mode, entropy encoding unit 56 may signal a QP_{Y} value of zero to indicate the lossless nature of the encoding of the block. However, if the block of residual data is empty, i.e. the residual is zero, then entropy encoding unit 56 may not be able to signal the cu_delta_qp. To mitigate or eliminate this issue, video encoder 20 and components thereof may implement one or more of the techniques described below with respect to FIG. 2.

In another example implementation of the techniques described herein, entropy encoding unit 56 may signal an indication that transform processing unit 52 did not perform any transform operations on a block of encoded residual video data, and that video encoder 20 did not apply any loop filters (namely, a deblocking filter, an SAO filter, and an ALF) in encoding the block of residual video data. In some instances, entropy encoding unit 56 may generate an indication, such as the transform_skip_lossless_flag described above, and signal the generated indication to indicate that no transform operations and no loop filtering were performed on the encoded block. In other instances, entropy encoding unit 56 may reuse the cu_transquant_bypass_flag, which is traditionally used to indicate coding according to transquant bypass mode, to indicate that no transform operations and no loop filtering were performed on the encoded block.

For instance, according to this implementation, entropy encoding unit 56 may signal the transform_skip_lossless_flag and/or the cu_transquant_bypass_flag based on the enablement status (e.g., value) of a higher-level flag. As one example, entropy encoding unit 56 may make the signaling of the transform_skip_lossless_flag and/or the cu_transquant_bypass_flag dependent on the enablement status of transquant_bypass_enabled_flag, which entropy encoding unit 56 may signal at the PPS-level, or alternatively, at the SPS-level or in a slice header. In various examples, entropy encoding unit 56 may signal the transform_skip_lossless_flag and/or the cu_transquant_bypass_flag for a CU group that includes the block of encoded residual video data. Entropy encoding unit 56 may determine the minimum size of a CU group using one or more of the calculations (such as IPCM parameter-based determinations) described above with respect to other implementations of the techniques of this disclosure. Additional details of this implementation are described below with respect to FIG. 4.

According to another implementation of the techniques described herein, entropy encoding unit 56 may mitigate or eliminate potential issues caused in scenarios where entropy encoding unit 56 is unable to signal the cu_delta_qp if a block of encoded residual data is empty, i.e., no residual data exists between the current block and the predictor block. According to this implementation, entropy encoding unit 56 may define a slice_transquant_bypass_flag, which entropy encoding unit 56 may use to indicate coding according to transquant bypass mode for an entire slice of a picture. As one example, if entropy encoding unit 56 determines that a block of encoded residual data was encoded losslessly, then entropy encoding unit 56 may enable the slice_transquant_bypass_flag to indicate lossless encoding with respect to the entire slice that includes the block. Additionally, if entropy encoding unit 56 enables the slice_transquant_bypass_flag, entropy encoding unit 56 may signal the cu_delta_qp at the beginning of a CU or corresponding CU group, and video encoder 20 may not apply any loop filters to 4×4 TUs of the slice for which the transform_skip_flag is enabled and the QP_{Y} value is associated with lossless coding.

Additionally, in accordance with this implementation, if entropy encoding unit 56 determines that the slice_transquant_bypass_flag is enabled (e.g., has a value of one), and that the QP_{Y} value for a block is associated with lossless encoding, then entropy encoding unit 56 may enforce signaling of the transform_skip_flag for 4×4 TUs of the slice. More specifically, by enforcing signaling of the transform_skip_flag, entropy encoding unit 56 may signal the transform_skip_flag even for 4×4 TUs for which the coding block flag (cbf) is set to a value of zero.

In addition, or as an alternative to enforcing signaling of the transform_skip_flag, entropy encoding unit 56 may determine that, if the slice_transquant_bypass_flag is enabled for a particular slice, then an CU of the slice for which the QP_{Y} value indicates lossless coding can include only 4×4 TUs. According to this additional feature, entropy encoding unit 56 may also determine that all 4×4 TUs of such a CU are associated with enabled transform_skip_flags. For instance, if entropy encoding unit 56 determines that the transform_skip_flag is absent for such a 4×4 TU, entropy encoding unit 56 may infer an enabled status (e.g., a value of one) for the transform_skip_flag with respect to such a 4×4 TU.

In another implementation of the techniques described herein, entropy encoding unit 56 may enforce bitstream conformance with respect to lossless encoding of a block of residual video data. For example, entropy encoding unit 56 may determine that a block with a zero residual value, the transform_skip_flag is enabled with respect to the block, and the QP of the block (or of the corresponding predictor block) is associated with a lossless coding mode. In this scenario, entropy encoding unit 56 may determine that the encoded bitstream in which the block is signaled does not include data associated with any losslessly coded blocks.

In addition, or alternatively to, the bitstream conformance features described above, entropy encoding unit 56 may implement other bitstream conformance features. For instance, entropy encoding unit 56 may implement bitstream conformance based on detecting that a QP of a block (or of the corresponding predictor block) is different from a value associated with a lossless coding mode. In this scenario, if entropy encoding unit 56 detects that the transform_skip_flag is enabled for the block, and the block has a zero residual value, then the encoded bitstream does not include data associated with any losslessly coded blocks.

Conversely, according to examples of this implementation, entropy encoding unit 56 may implement bitstream conformance to determine that an encoded bitstream includes data for only losslessly coded blocks, i.e. that the encoded bitstream does not include data associated with any lossy coded blocks. More specifically, in some instances, entropy encoding unit 56 may determine that a block of residual video data has a disabled transform_skip_flag (e.g., set to a value of zero), that the residual block is empty (i.e., has a zero residual). In such instances, entropy encoding unit 56 may determine that the encoded bitstream does not include any lossy coded blocks. In some variations of this implementation, entropy encoding unit 56 may further condition the bitstream conformance on additional conditions being met, such as the QP of the block (or of the corresponding predictor block) having a value of four, or other value associated with lossless coding.

Alternatively, according to this implementation, entropy encoding unit 56 may determine a default enablement status (or ‘infer’ an enablement status) for the transform_skip_flag based on one or more criteria. For instance, if the QP of the block (or of the corresponding predictor block) is associated with lossless coding, entropy encoding unit 56 may infer that the transform_skip_flag is enabled (e.g., set to a value of one) for the block of residual video data. As another example, entropy encoding unit 56 may determine that the QP of the block (or of the corresponding predictor block) is associated with a lossy coding mode, and that the block of residual video data is empty (i.e., the current block produces a zero residual in comparison to the predictor block). In such a scenario, entropy encoding unit 56 may infer the transform_skip_flag to be disabled (e.g., set to a value of zero) for the block of residual video data.

By implementing bitstream conformance as described with respect to this implementation, entropy encoding unit 56 may provide one or more potential advantages. For instance, entropy encoding unit 56 may enable quantization unit 54 and other components of video encoder 20 to use a full range of available QP values, instead of being restricted to using a reduced range of QP values. As one example, under this implementation of the techniques of this disclosure, quantization unit 54 may use a QP values ranging from 0-51. More specifically, under this implementation, entropy encoding unit 56 may determine a lossless coding mode based on a particular QP value (e.g., four), while applying quantization and/or loop filtering in case of certain other QP values of the available range.

In still another implementation, if mode select unit 40 selects an inter-coding mode, entropy encoding unit 56 may skip a block by sending a skip_flag value of 1. For such skipped blocks, entropy encoding unit 56 may enable a lossless coding mode, such as a transform skip mode or transquant bypass mode, or a merge skip mode, in a number of ways. For instance, entropy encoding unit 56 may signal a transform_skip_flag for each CU, such that the transform_skip_flag is signaled before the corresponding skip_flag. In this example, mode select unit 40 and/or entropy encoding unit 56 may also enable lossless coding in accordance with the merge skip inter mode. For instance, mode select unit 40 and/or entropy encoding unit 56 may determine that, under these conditions, the merge skip inter mode is a lossless coding mode. As another example in accordance with this implementation, entropy encoding unit 56 may signal the transform_skip_flag before signaling the corresponding skip_flag only for a QP value associated with lossless mode (e.g., QP value of four). As encoding according to merge skip mode does not include a transform operation, the transform_skip_flag is necessary only to indicate encoding by entropy encoding unit 56 according to a lossless coding mode. Thus, entropy encoding unit 56, in using the merge skip mode, may encode a block losslessly if the block is associated with a luma QP value of four and an enabled transform_skip_flag (e.g., having a value of one). As yet another example according to this implementation, entropy encoding unit 56 may signal an additional transform_skip_flag after the corresponding skip_flag for every QP, or for only those QP values associated with a lossless mode (e.g., QP values of four).

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

Video encoder 20 of FIG. 2 represents an example of a video encoder configured to code data for a plurality of pictures in a picture coding order, wherein the data indicates that the plurality of pictures are each available for use as long-term reference pictures, and code values for least significant bits (LSBs) of picture order count (POC) values of the plurality of pictures such that the values for the LSBs are either non-decreasing or non-increasing in the picture coding order.

In this manner, video encoder 20 may, in examples, be configured to perform a method that includes determining whether to encode a block of residual video data losslessly in accordance with a lossless coding mode, based on whether transform operations are skipped during encoding of the block of residual video data, and if the block of residual video data is to be encoded losslessly, then encoding the block of residual video data according to the lossless coding mode, to form an encoded block of residual video data, where encoding the block of residual video data comprises bypassing quantization and sign hiding during encoding the block of residual video data, and bypassing all loop filters with respect to a reconstructed block of video data that is based on the encoded block of residual video data.

In examples, video encoder 20 may be included in a device for coding video data, such as a desktop computer, notebook (i.e., laptop) computer, tablet computer, set-top box, telephone handset such as a so-called “smart” phone, so-called “smart” pad, television, camera, display device, digital media player, video gaming console, video streaming device, or the like. In examples, such a device for coding video data may include one or more of an integrated circuit, a microprocessor, and a communication device that includes video encoder 20.

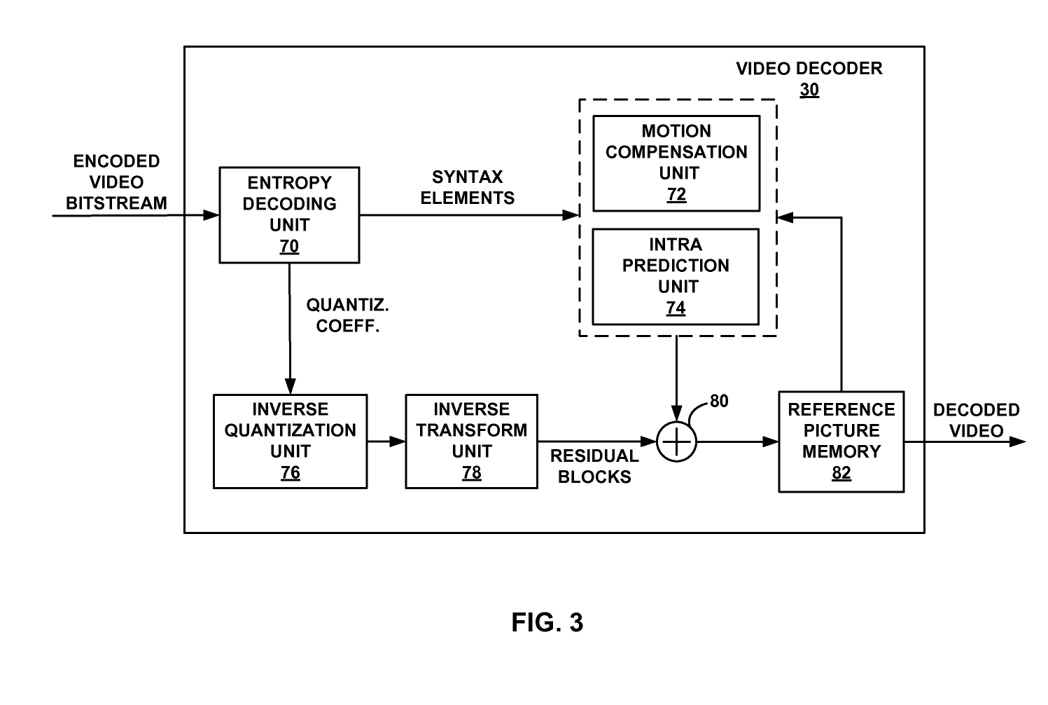

FIG. 3 is a block diagram illustrating an example of video decoder 30 that may implement techniques for decoding video data that has been encoded using parallel motion estimation. In the example of FIG. 3, video decoder 30 includes an entropy decoding unit 70, motion compensation unit 72, intra prediction unit 74, inverse quantization unit 76, inverse transformation unit 78, summer 80, and reference picture memory 82. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de quantizes, the quantized transform coefficients provided in the bitstream and decoded by entropy decoding unit 80. The inverse quantization process may include use of a quantization parameter QPY calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

Video decoder 30, and various components thereof, may implement techniques of this disclosure, such as techniques described with respect to lossless and lossy coding of a block of residual video data. For instance, in an implementation where video encoder 20 forces signaling of a cu_delta_qp based on selecting particular prediction modes, entropy decoding unit 70 may determine an indication of a coding mode, such as a fallback mode, used by video encoder 20. Based on the indicated coding mode, entropy decoding unit 70 may provide specific data to one or both of inverse quantization unit 76 and inverse transform unit 78. For example, if entropy decoding unit 70 determines that a block of residual video data was encoded according to transform skip mode (e.g., based on an enabled cu_transform_skip_flag), then entropy decoding unit 70 may provide data to inverse transform unit 78 that causes inverse transform unit 78 to not perform any inverse transform operations with respect to the encoded block. As another example, if entropy decoding unit 70 determines that a block of residual video data was encoded according to transquant bypass mode (e.g., based on an enabled cu_transquant_bypass_flag), entropy decoding unit 70 may provide data to inverse quantization unit 76 that causes inverse quantization unit 76 to not perform any inverse quantization operations with respect to the block. As still another example, if entropy decoding unit 70 determines that the bitstream includes an indication that the QP value for the block is set to four (i.e., quantization step size is one), entropy decoding unit 70 may provide data to inverse quantization unit 76 that causes inverse quantization unit 76 to not perform any inverse quantization operations with respect to the block

Additionally, if entropy decoding unit 70 determines an enabled cu_transquant_bypass_flag with respect to a block of residual video data, entropy decoding unit 70 may cause video decoder 30 to not apply any loop filters (namely, a deblocking filter, an SAO filter, and an ALF) to the block of residual video data. According to this implementation, entropy decoding unit 70 may detect one or both of the cu_transform_skip_flag and the cu_transquant_bypass_flag at various syntax levels, such as levels higher than the CU level (e.g., at a CU group-level).

In implementations where video encoder 20 signals the cu_delta_qp at the beginning of a CU or a CU group, entropy decoding unit 70 may provide quantization coefficients to inverse quantization unit 76 such that inverse quantization unit 76 may de-quantize the CU or the CU group according to the cu_delta_qp determined by entropy decoding unit 70 from the received encoded video bitstream. Similarly, in implementations where video encoder 20 signals the cu_delta_qp as part of a slice header of an encoded picture, entropy decoding unit 70 may provide quantization coefficients to inverse quantization unit 76 such that inverse quantization unit 76 may de-quantize the entire slice according to the cu_delta_qp determined by entropy decoding unit 70 from the received encoded video bitstream.

In an implementation where video encoder 20 generates and signals a transform_skip_lossless_flag, or signals a cu_transquant_bypass_flag, to indicate lossless coding, entropy decoding unit 70 may use the value of the signaled flag to provide data to inverse quantization unit 76 and/or other components of video decoder 30. For instance, if entropy decoding unit 70 detects that the signaled flag is enabled (e.g., set to a value of one), entropy decoding unit 70 may provide quantization coefficients to inverse quantization unit 76 that cause inverse quantization unit 76 to not perform any de-quantization operations on the block of residual video data. Similarly, if entropy decoding unit 70 detects that either the generated transform_skip_lossless_flag or the transform_skip_flag is enabled, entropy decoding unit 70 may provide data to inverse transform unit 78 that causes inverse transform unit 78 to not perform any inverse transform operations with respect to the block of residual video data.

Conversely, if entropy decoding unit 70 determines that the transform_skip_lossless_flag is disabled (e.g., set to a value of zero), entropy decoding unit 70 may provide quantization coefficients to inverse quantization unit 76 that cause inverse quantization unit 76 to de-quantize the block, and may also cause video decoder 30 to apply one or more loop filters, such as a deblocking filter, to the block of residual video data. Additionally, if, according to this implementation, video encoder 20 determines that a losslessly encoded CU may include only 4×4 TUs, then, in instances where entropy decoding unit 70 determines that the transform_skip_flag is absent, entropy decoding unit 70 may infer that the transform_skip_flag is enabled (e.g., set to a value of one). Further details of this implementation are described below with respect to FIG. 4.

In an implementation where video encoder 20 generates a slice_transquant_bypass_flag and signals the generated flag in the slice header, entropy decoding unit 70 may provide quantization coefficients to inverse quantization unit 76 with respect to the entire slice of the picture. In turn, inverse quantization unit 76 may de-quantize all blocks of video data included in the slice, based on the quantization coefficients that entropy decoding unit 70 determines based on the value of the slice_transquant_bypass_flag. Additionally, if, according to this implementation, video encoder 20 determines that a losslessly encoded CU may include only 4×4 TUs, then, in instances where entropy decoding unit 70 determines that the transform_skip_flag is absent, entropy decoding unit 70 may infer that the transform_skip_flag is enabled (e.g., set to a value of one).

In instances where video encoder 20 does not signal a transform_skip_flag for a block, video decoder 30 may not be able to distinguish between lossless and lossy coding modes. In turn, one or more components of video decoder 30, such as entropy decoding unit 70 may not be able to decode such a block according to the correct coding mode, resulting in mismatch. As described above, in one implementation of the techniques of this disclosure, video encoder 20 may implement bitstream conformance, thereby restricting an encoded bitstream to include either exclusively losslessly encoded blocks, or exclusively lossy coded blocks.

In an implementation where video encoder 20 implements bitstream conformance based on one or more attributes of a block of residual video data, entropy decoding unit 70 may determine lossless or lossy coding with respect to an entire received encoded video bitstream. In a specific example, in instances where a block has a zero residual value, the transform_skip_flag is enabled with respect to the block, and the QP of the block (or of the corresponding predictor block) is associated with a lossless coding mode, entropy decoding unit 70 may determine that the encoded bitstream in which the block is signaled does not include data associated with any losslessly coded blocks. As another example, in instances where a QP of a block (or of the corresponding predictor block) is different from a value associated with a lossless coding mode, the transform_skip_flag is enabled for the block, and the block has a zero residual value, entropy decoding unit 70 may determine that the encoded bitstream does not include data associated with any losslessly coded blocks.

Conversely, according to examples of this implementation, in instances where a block of residual video data has a disabled transform_skip_flag (e.g., set to a value of zero), and that the residual block is empty (i.e., has a zero residual) entropy decoding unit 70 may determine that the encoded bitstream does not include any lossy coded blocks. In some variations of this implementation, entropy decoding unit 70 may detect the bitstream conformance (i.e., of having no lossy coded blocks) based on additional conditions being met, such as the QP of the block (or of the corresponding predictor block) having a value of four, or other value associated with lossless coding.

Alternatively, according to this implementation, entropy decoding unit 70 may determine a default enablement status (or ‘infer’ an enablement status) for the transform_skip_flag based on one or more criteria. For instance, if the QP of the block (or of the corresponding predictor block) is associated with lossless coding, entropy decoding unit 70 may infer that the transform_skip_flag is enabled (e.g., set to a value of one) for the block of residual video data. As another example, entropy decoding unit 70 may determine that the QP of the block (or of the corresponding predictor block) is associated with a lossy coding mode, and that the block of residual video data is empty (i.e., the current block produces a zero residual in comparison to the predictor block). In such a scenario, entropy decoding unit 70 may infer the transform_skip_flag to be disabled (e.g., set to a value of zero) for the block of residual video data.

In implementations where video encoder 20 encodes a block using a lossless inter-coding mode, such as merge skip mode under certain conditions, entropy decoding unit 70 detect an enabled skip_flag (e.g., having a value of one) signaled by video encoder 20. Additionally, based on detecting the enabled skip_flag, entropy decoding unit 70 may skip a block in decoding the encoded bitstream. Entropy decoding unit 70 may also detect that such a skipped block was encoded according to a lossless coding mode, such as a transform skip mode, transquant bypass mode, or merge skip mode, in a number of ways. For instance, entropy decoding unit 70 may detect a transform_skip_flag for each CU, signaled before the corresponding skip_flag for the CU. In such examples, entropy decoding unit 70 may detect lossless coding of a block if the block was encoded according to merge skip mode. As another example in accordance with this implementation, entropy decoding unit 70 may detect that a transform_skip_flag is signaled before the corresponding skip_flag only for a QP value associated with lossless mode (e.g., QP value of four). As encoding according to merge skip mode does not include a transform operation, entropy decoding unit may use the value of the transform_skip_flag to determine whether inverse transform unit 78 performs any inverse transform operations with respect to the block. Thus, entropy encoding unit 70 may, in cases where a block is encoded according to merge skip mode, decode a block losslessly if the block is associated with a luma QP value of four and an enabled transform_skip_flag (e.g., having a value of one). As yet another example according to this implementation, entropy decoding unit 70 may detect an additional transform_skip_flag signaled after the corresponding skip_flag for every QP, or for only those QP values associated with a lossless mode (e.g., QP values of four).

In this manner, video decoder 30 may, in examples, be configured to perform a method that includes determining whether an encoded block of residual video data was encoded losslessly in accordance with a lossless coding mode, based on whether transform operations were skipped during encoding of the block of residual video data, and if the block of residual video data was encoded losslessly, then decoding the encoded block of residual video data according to the lossless coding mode to form a reconstructed block of residual video data, where decoding the encoded block of residual data comprises bypassing quantization and sign hiding while decoding the encoded block of residual video data, and bypassing all loop filters with respect to the reconstructed block of residual video data.

In examples, video decoder 30 may be included in a device for coding video data, such as a desktop computer, notebook (i.e., laptop) computer, tablet computer, set-top box, telephone handset such as a so-called “smart” phone, so-called “smart” pad, television, camera, display device, digital media player, video gaming console, video streaming device, or the like. In examples, such a device for coding video data may include one or more of an integrated circuit, a microprocessor, and a communication device that includes video decoder 30.

FIG. 4 is a conceptual diagram illustrating an example coding unit (CU) 100 that video decoder 30 may receive from video decoder 20, in accordance with one or more aspects of this disclosure. More specifically, video encoder 20 may encode CU 100 according to one or more techniques of this disclosure that enable video encoder 20 to generate a transform_skip_lossless_flag to indicate whether video encoder 20 encoded the TU according to transform skip mode, and that video encoder 20 did not perform any quantization operations with respect to the TU. In the example of FIG. 4, CU 100 includes losslessly coded region 110. Losslessly coded region 110, in turn, includes a 4×4 TU grouping, namely, a grouping of losslessly coded blocks 102-108.

Specifically, according to this implementation, video decoder 30 may detect, for each of losslessly coded blocks 102-108, an enabled transform_skip_lossless_flag (e.g., having a value of one) signaled by video encoder 20. In some examples, CU 100 may represent the minimum CU group size determined by video encoder 20 and/or video decoder 30, for which video encoder 20 may signal one or more instances of the transform_skip_lossless_flag.

As described, video decoder 30 may detect an enabled transform_skip_lossless-_flag for each TU of losslessly coded region 110. Conversely, video decoder 30 may detect a disabled transform_skip_lossless_flag (e.g., having a value of zero) for the remaining portions of CU 100 (not called out in FIG. 4 for ease of illustration purposes only). FIG. 4 illustrates an example in which video encoder 20 may generate a transform_skip_lossless_flag for each TU of CU 100, and signal an indication of losslessly coded region 110 by enabling the transform_skip_lossless_flag with respect to each of losslessly coded blocks 102-108, while disabling the transform_skip_lossless_flag with respect to the remaining portions of CU 100.

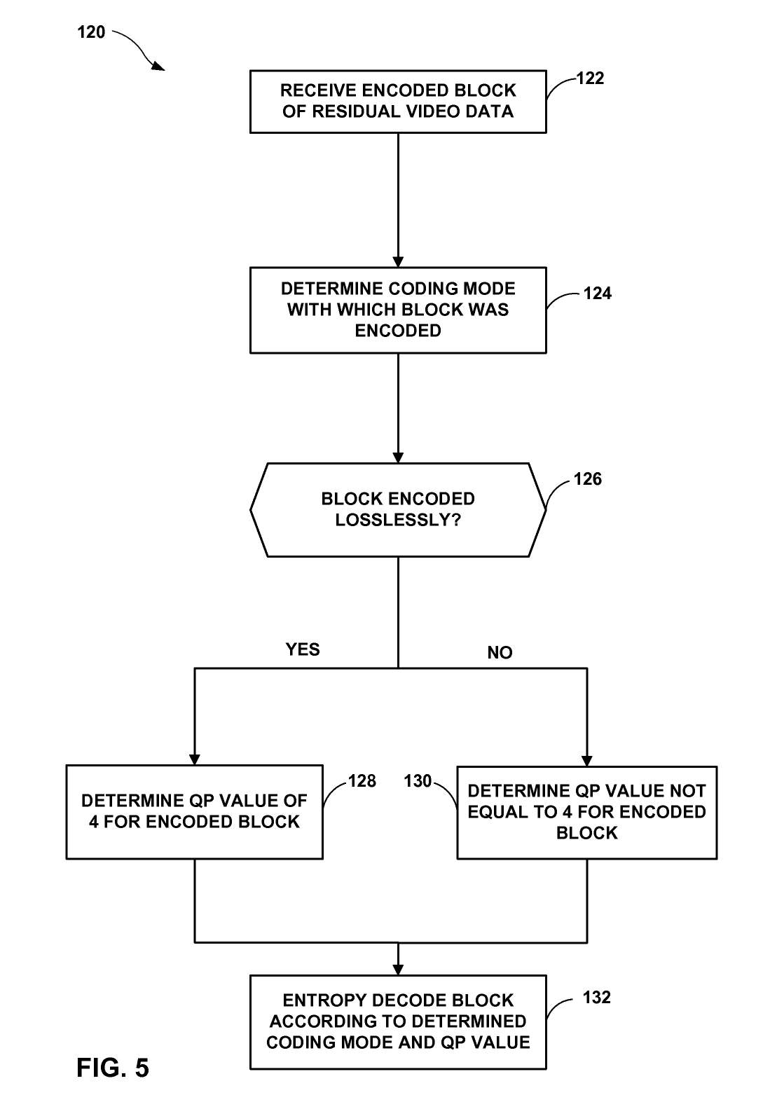

FIG. 5 is a flowchart illustrating an example process 120 that video decoder 30, and/or components thereof, may implement, in accordance with one or more aspects of this disclosure. Process 120 may begin when video decoder 30 receives an encoded block of residual video data (122). For instance, video decoder 30 may receive the encoded block as part of an encoded bitstream, signaled via link 16.

Video decoder 30 may determine a coding mode with which the received block was encoded (124). In examples, video decoder 30 may determine the coding mode from a plurality of coding modes that includes at least one lossless coding mode. Examples of lossless coding modes include the transform skip mode and the transquant bypass mode described above.

Additionally, video decoder 30 may determine whether the encoded block of residual data was encoded losslessly (126). In various examples, video decoder 30 may determine whether the block was encoded losslessly based on one or more indications signaled in the received encoded bitstream, such as one or more flags, including the transform_skip_flag, the transform_bypass_flag, and the transform_skip_lossless_flag, to list just a few examples.

Based on the determination of whether the encoded residual block was encoded losslessly (126), video decoder 30 may determine a quantization parameter (QP) for the encoded residual block. For instance if video decoder 30 determines that the encoded residual block was encoded losslessly (YES branch of 126), video decoder 30 may determine a QP value of four for the encoded residual block (128). Conversely, if video decoder 30 determines that the encoded residual block was not encoded losslessly (NO branch of 126), video decoder 30 may determine a QP value that is not equal to four for the encoded residual block (130). As described above, while the QP value of four is used herein as an example for lossless coding, in various implementations, video decoder 30 may associate different QP values with lossless coding.

Video decoder 30 may entropy decode the encoded residual block according to the determined coding mode with which the block was encoded, and based on the determined QP value (132). As one example, if video decoder 30 determines that the block was encoded according to a lossless coding mode, such as transform skip mode indicated by an enabled transform_skip_flag, then video decoder 30 may entropy decode the encoded residual block according to transform skip mode. Additionally, video decoder 30 may, in entropy decoding the encoded residual block, de-quantize the block using a QP value of four (determined at 128).

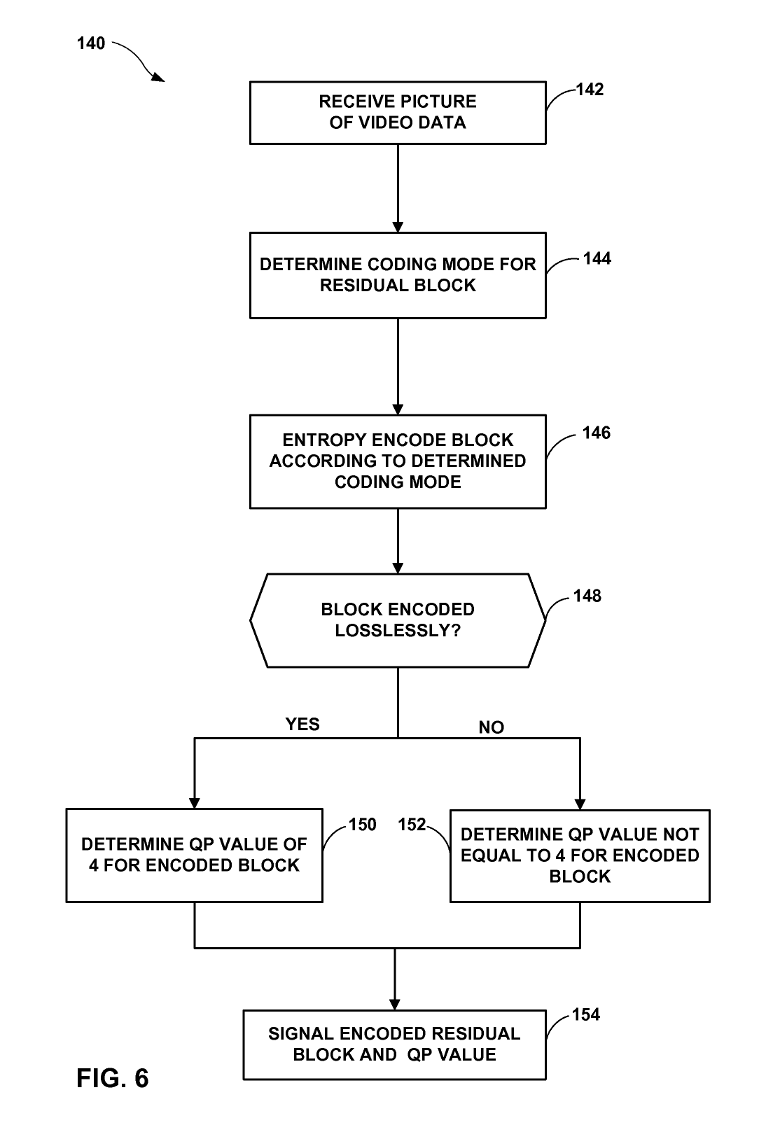

FIG. 6 is a flowchart illustrating an example process 140 that video encoder 20, and components thereof, may implement, in accordance with one or more aspects of this disclosure. Process 140 may begin when video encoder 20 receives a picture of video data (142). In one example, video encoder 20 may receive the picture from video source 18 of source device 12 illustrated in FIG. 1.

Video encoder 20 may determine a coding mode for a residual block of video data associated with the picture (144). For instance, video encoder 20 may determine the coding mode from a plurality of coding modes for a block of residual video data, where the plurality of coding modes includes at least one lossless coding mode. Examples of lossless coding modes include transform skip mode and transquant bypass mode. Video encoder 20 may determine the coding mode for the purpose of entropy encoding the block of residual video data.

Additionally, video encoder 20 may entropy encode the block of residual video data according to the determined coding mode (146). The entropy encoding coding process may result in video encoder 20 forming an encoded block of residual video data. As an example, if the determined coding mode is a lossless coding mode, such as the transform skip mode or the transquant bypass mode, then the entropy encoding process may be a lossless process, i.e., video encoder 20 may encode the block of residual video data losslessly.

Video encoder 20 may determine whether the encoded block of residual video data was encoded losslessly (148). In some examples, video encoder 20 may determine whether the encoded block was encoded losslessly based on an indication of encoding according to a particular coding mode. For instance, if video encoder 20 determines that a transform_skip_flag is enabled, video encoder 20 may determine that the encoded block was encoded according to the transform skip mode, i.e., that the encoded block was encoded losslessly. Additionally, video encoder 20 may determine a quantization parameter (QP) associated with the encoded block of residual video data based on the determination of whether the encoded block of residual video data was coded losslessly

If video encoder 20 determines that the encoded block of residual video data was encoded losslessly (YES branch of 148), video encoder 20 may determine a QP value of four for the encoded block of residual video data (150). For instance, the QP value of four may be associated with lossless encoding of the block. Conversely, if video encoder 20 determines that the encoded residual block was not encoded losslessly (NO branch of 148), video encoder 20 may determine a QP value that is not equal to four for the encoded residual block (152). As described above, while the QP value of four is used herein as an example for lossless coding, in various implementations, video encoder 20 may associate different QP values with lossless coding.

Video encoder 20 may signal data associated with the encoded block of residual video data and the determined QP value, such as via link 16 (154). In examples, video encoder 20 may signal additional data associated with the encoded block and the QP value, such as indications of the determined coding mode, such as an enabled or disabled transform_skip_flag associated with the transform skip mode. In some examples, video encoder 20 may implement bitstream conformance based on the determined coding mode and/or the QP value, such as by restricting the bitstream to include data associated only with losslessly coded blocks or, conversely, with lossy coded blocks.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data comprising:
determining whether an encoded block of residual video data was encoded losslessly in accordance with a lossless coding mode, based on whether transform operations were skipped during encoding of the block of residual video data; and
if the block of residual video data was encoded losslessly, then decoding the encoded block of residual video data according to the lossless coding mode to form a reconstructed block of residual video data,
wherein decoding the encoded block of residual data comprises bypassing quantization and sign hiding while decoding the encoded block of residual video data, and bypassing all loop filters with respect to the reconstructed block of residual video data.

2. The method of claim 1,
wherein determining whether the encoded block of residual data was encoded losslessly comprises determining whether a transform_skip_lossless_flag associated with the encoded block of residual video data is enabled, and
wherein, if the transform_skip_lossless_flag is enabled, the enabled transform_skip_lossless_flag indicates that, in addition to the transform operations being skipped, quantization and sign hiding, were bypassed during encoding of the encoded block of residual video data, and all loop filters are bypassed with respect to the reconstructed block of residual video data.

3. The method of claim 2, wherein determining whether the transform_skip_lossless_flag is enabled for the encoded block of residual video data comprises determining whether the transform_skip_lossless_flag is enabled for a group of blocks of video data included in the encoded block of residual video data.

4. The method of claim 3, wherein the group of blocks comprises a 4×4 transform unit (TU) group.

5. The method of claim 1,
wherein determining whether the encoded block of residual video data was encoded losslessly comprises determining whether a slice_transquant_bypass_flag is enabled for a slice of a picture, the slice including the encoded block of residual data, and
wherein, if the slice_transquant_bypass_flag is enabled, the enabled slice_transquant_bypass_flag slice indicates that, in addition to the transform operations being skipped for the encoded block of residual video data, sign hiding, and all loop filters were bypassed if a quantization parameter (QP) value associated with the encoded block of residual video data indicates a quantization step size equal to 1.

6. The method of claim 5, further comprising determining that a delta_qp value is signaled at a beginning of a coding unit associated with the slice of the picture.

7. The method of claim 1,
wherein determining whether the encoded block of residual video data was encoded losslessly comprises determining whether at least one of a cu_transform_skip_flag, a cu_transquant_bypass_flag, and a transform_skip_lossless_flag is enabled for a block group, the block group including the encoded block of residual data, and
wherein, if at least one of the cu_transform_skip_flag, the cu_transquant_bypass_flag, and the transform_skip_lossless_flag is enabled, the enabled at least one of the cu_transform_skip_flag, the cu_transquant_bypass_flag, and the transform_skip_lossless_flag indicates that, in addition to the transform operations being skipped, quantization, sign hiding, and all loop filters were bypassed during encoding of the encoded block of residual video data.

8. The method of claim 7, wherein a minimum size of the block group is determined based on one of a formula, one or more parameters that specify an intra pulse code modulation (IPCM) block size, or a quantization group size signaling a delta_qp value.

9. The method of claim 8, wherein the formula is one of a) Log₂ MinCUgroupSize=Log₂ MaxCUSize−diff_cu_bypass_depth, or b) Log₂ MinCUgroupSize=Log₂ MaxCUSize−(diff_cu_bypass_depth−1),
wherein MaxCUSize is associated with a maximum coding unit (CU) size, and diff_cu_bypass_depth is associated with a difference between a maximum size and a minimum CU size.

10. The method of claim 1,
wherein the lossless coding mode comprises at least one of a transform skip mode and a transquant bypass mode, and
wherein determining whether the encoded block of residual video data was encoded losslessly comprises determining at least one of an indication of encoding according to the transform skip mode, an indication of encoding according to the transquant bypass mode, and an indication that the encoded block of residual video data is empty.

11. The method of claim 1, wherein determining whether the encoded block of residual video data was encoded losslessly comprises determining whether at least one of a transform_skip_flag, a transquant bypass_flag, and a transform skip loop filter flag is enabled.

12. The method of claim 1, wherein the determination of whether the encoded block of residual video data was encoded losslessly applies to an encoded bitstream that includes data corresponding to the encoded block of residual video data.

13. The method of claim 12, further comprising:
determining that the encoded block of residual video data comprises one or more residual values of 0, and that at least one of a quantization parameter (QP) associated with the encoded block of residual video data or a predicted QP associated with the encoded block of residual video data comprises a value associated with the lossless coding mode; and
based on the determination that the encoded block of residual video data comprises the residual values of 0, and that at least one of the QP associated with the encoded block of residual video data or the predicted QP associated with the encoded block of residual video data comprises the value associated with the lossless coding mode, determining that the encoded bitstream does not include any data associated with any encoded block of video data that comprises the residual values of 0, and that at least one of the QP associated with the encoded block of residual video data or the predicted QP associated with the encoded block of residual video data comprises the value associated with the lossless coding mode.

14. A method of encoding video data, the method comprising:
determining whether to encode a block of residual video data losslessly in accordance with a lossless coding mode, based on whether transform operations are skipped during encoding of the block of residual video data; and
if the block of residual video data is to be encoded losslessly, then encoding the block of residual video data according to the lossless coding mode, to form an encoded block of residual video data,
wherein encoding the block of residual video data comprises bypassing quantization and sign hiding during encoding the block of residual video data, and bypassing all loop filters with respect to a reconstructed block of video data that is based on the encoded block of residual video data.

15. The method of claim 14,
wherein determining whether to encode the block of residual data losslessly comprises determining whether to enable a transform_skip_lossless_flag associated with the block of residual video data, and
wherein, if the transform_skip_lossless_flag is enabled, the enabled transform_skip_lossless_flag indicates that, in addition to skipping the transform operations, quantization and sign hiding are bypassed during encoding of the encoded block of residual video data, and all loop filters are bypassed with respect to the reconstructed block of residual video data.

16. The method of claim 15, wherein determining whether the transform_skip_lossless_flag is enabled for the block of residual video data comprises determining whether the transform_skip_lossless_flag is enabled for a group of blocks of video data included in the block of residual video data.

17. The method of claim 16, wherein the group of blocks comprises a 4×4 transform unit (TU) group.

18. The method of claim 14,
wherein determining whether to encode the block of residual video data losslessly comprises determining whether to enable a slice_transquant_bypass_flag for a slice of a picture, the slice including the block of residual data, and
wherein, if the slice_transquant_bypass_flag is enabled, the enabled slice_transquant_bypass_flag slice indicates that, in addition to the transform operations being skipped, sign hiding, and all loop filters are bypassed if a quantization parameter (QP) value associated with the encoded block of residual video data indicates a quantization step size equal to 1.

19. The method of claim 18, further comprising signaling a delta_qp value at a beginning of a coding unit associated with the slice of the picture.

20. The method of claim 14,
wherein determining whether to encode the block of residual video data losslessly comprises determining whether to enable at least one of a cu_transform_skip_flag, a cu_transquant_bypass_flag, and a transform_skip_lossless_flag for a block group, the block group including the block of residual data to be encoded, and
wherein, if at least one of the cu_transform_skip_flag, the cu_transquant_bypass_flag, and the transform_skip_lossless_flag is enabled, the enabled at least one of the cu_transform_skip_flag, the cu_transquant_bypass_flag, and the transform_skip_lossless_flag indicates that, in addition to the transform operations being skipped, quantization, sign hiding, and all loop filters are bypassed during encoding of the block of residual video data.

21. The method of claim 20, further comprising determining the minimum size of the block group based on one of a formula, one or more parameters that specify an intra pulse code modulation (IPCM) block_size, or a quantization group size signaling a delta_qp value.

22. The method of claim 21, wherein the formula is one of a) Log₂ MinCUgroupSize=Log₂ MaxCUSize−diff_cu_bypass_depth, or b) Log₂ MinCUgroupSize=Log₂ MaxCUSize−(diff_cu_bypass_depth−1),
wherein MaxCUSize is associated with a maximum coding unit (CU) size, and diff_cu_bypass_depth is associated with a difference between a maximum size and a minimum CU size.

23. The method of claim 14, wherein the lossless coding mode comprises at least one of a transform skip mode and a transquant bypass mode, the method further comprising signaling an indication of encoding according to the transform skip mode, an indication of encoding according to the transquant bypass mode, and an indication that the encoded block of residual video data is empty.

24. The method of claim 14, wherein determining whether to encode the block of residual video data losslessly comprises determining whether to enable at least one of a transform skip flag, a transquant bypass flag, and a transform skip loop filter flag.

25. The method of claim 14, wherein the determination of whether to encode the block of residual video data losslessly applies to an encoded bitstream to be signaled, the encoded bitstream including data corresponding to the encoded block of residual video data.

26. The method of claim 25, further comprising:
determining that the encoded block of residual video data comprises one or more residual values of 0, and that at least one of a quantization parameter (QP) associated with the encoded block of residual video data or a predicted QP associated with the encoded block of residual video data comprises a value associated with the lossless coding mode; and
based on the determination that the encoded block of residual video data comprises the one or more residual values of 0, and that at least one of the QP associated with the encoded block of residual video data or the predicted QP associated with the encoded block of residual video data comprises the value associated with the lossless coding mode, determining that the encoded bitstream does not include any data associated with any encoded block of video data that comprises the one or more residual values of 0, and that at least one of the QP associated with the encoded block of residual video data or the predicted QP associated with the encoded block of residual video data comprises the value associated with the lossless coding mode.

27. The method of claim 14, further comprising enabling signaling of a quantization parameter (QP) value associated with the encoded block of residual video data at least in part by:
selecting a coding mode by which to encode the block of residual video data, such that the selected coding mode causes signaling of the QP associated with the encoded block of residual data.

28. A device for coding video data, the device comprising a video coder configured to:
determine whether to code a block of residual video data losslessly in accordance with a lossless coding mode, based on whether transform operations are skipped during coding of the block of residual video data; and
if the block of residual video data is to be coded losslessly, then code the block of residual video data according to the lossless coding mode to form a reconstructed block of residual video data,
wherein, to code the block of residual data, the device is configured to bypass quantization and sign hiding while coding the block of residual video data, and bypassing all loop filters with respect to the reconstructed block of residual video data.

29. The device of claim 28,
wherein, to determine whether to code the block of residual data losslessly, the device is configured to determine whether a transform_skip_lossless_flag associated with the encoded block of residual video data is enabled, and
wherein, if the transform_skip_lossless_flag is enabled, the enabled transform_skip_lossless_flag indicates that, in addition to the transform operations being skipped, quantization and sign hiding are bypassed during coding the encoded block of residual video data, and all loop filters are bypassed with respect to the reconstructed block of residual video data.

30. The device of claim 29, wherein, to determine whether the transform_skip_lossless_flag is enabled for the block of residual video data, the device is configured to determine whether the transform_skip_lossless_flag is enabled for a group of blocks of video data included in the block of residual video data.

31. The device of claim 30, wherein the group of blocks comprises a 4×4 transform unit (TU) group.

32. The device of claim 28,
wherein, to determine whether to code the block of residual video data losslessly, the device is configured to determine whether a slice_transquant_bypass_flag is enabled for a slice of a picture, the slice including the encoded block of residual data, and
wherein, if the slice_transquant_bypass_flag is enabled, the enabled slice_transquant_bypass_flag slice indicates that, in addition to the transform operations being skipped for the block of residual video data, sign hiding and all loop filters are bypassed if a quantization parameter (QP) value associated with the block of residual video data indicates a quantization step size equal to 1.

33. The device of claim 32, further configured to determine that a delta_qp value is signaled at a beginning of a coding unit associated with the slice of the picture.

34. The device of claim 28,
wherein, to determine whether to code the block of residual video data losslessly, the device is configured to determine whether at least one of a cu_transform_skip_flag, a cu_transquant_bypass_flag, and a transform_skip_lossless_flag is enabled for a block group, the block group including the encoded block of residual data, and
wherein, if at least one of the cu_transform_skip_flag, the cu_transquant_bypass_flag, and the transform_skip_lossless_flag is enabled, the enabled at least one of the cu_transform_skip_flag, the cu_transquant_bypass_flag, and the transform_skip_lossless_flag indicates that, in addition to the transform operations being skipped, quantization, sign hiding, and all loop filters are bypassed during coding of the block of residual video data.

35. The device of claim 34, wherein a minimum size of the block group is determined based on one of a formula, one or more parameters that specify an intra pulse code modulation (IPCM) block size, or a quantization group size signaling a delta_qp value.

36. The device of claim 35, wherein the formula is one of a) Log₂ MinCUgroupSize=Log₂ MaxCUSize−diff_cu_bypass_depth, or b) Log₂ MinCUgroupSize=Log₂ MaxCUSize−(diff_cu_bypass_depth−1),
wherein MaxCUSize is associated with a maximum coding unit (CU) size, and diff_cu_bypass_depth is associated with a difference between a maximum size and a minimum CU size.

37. The device of claim 28,
wherein the lossless coding mode comprises at least one of a transform skip mode and a transquant bypass mode, and
wherein, to determine whether to code the block of residual video data losslessly, the device is configured to determine at least one of an indication of encoding according to the transform skip mode, an indication of encoding according to the transquant bypass mode, and an indication that the encoded block of residual video data is empty.

38. The device of claim 28, wherein, to determine whether to code the block of residual video data losslessly, the device is configured to determine whether at least one of a transform skip flag, a transquant bypass flag, and a transform skip loop filter flag is enabled.

39. The device of claim 28, wherein the determination of whether to code the block of residual video data losslessly applies to an encoded bitstream that includes data corresponding to the block of residual video data.

40. The device of claim 39, further configured to:
determine that the block of residual video data comprises one or more residual values of 0, and that at least one of a quantization parameter (QP) associated with the block of residual video data or a predicted QP associated with the block of residual video data comprises a value associated with the lossless coding mode; and
based on the determination that the block of residual video data comprises the one or more residual values of 0, and that at least one of the QP associated with the block of residual video data or the predicted QP associated with the block of residual video data comprises the value associated with the lossless coding mode, determining that the encoded bitstream does not include any data associated with any block of video data that comprises the residual value of 0, and that at least one of the QP associated with the block of residual video data or the predicted QP associated with of the block of residual video data comprises the value associated with the lossless coding mode.

41. A device for coding video data, the device comprising:
means for determining whether to code a block of residual video data losslessly in accordance with a lossless coding mode, based on whether transform operations are skipped during coding of the block of residual video data to form a reconstructed block of residual video data; and
means for, if the block of residual video data is to be coded losslessly, then coding the block of residual video data according to the lossless coding mode,
wherein the means for coding the block of residual data comprises means for bypassing quantization and sign hiding while coding the block of residual video data, and bypassing all loop filters with respect to the reconstructed block of residual video data.

42. A computer-readable storage device having stored thereon instructions that, when executed, cause one or more programmable processors of a computing device to:
determine whether to code a block of residual video data losslessly in accordance with a lossless coding mode, based on whether transform operations are skipped during coding of the block of residual video data; and
if the block of residual video data is to be coded losslessly, then coding the block of residual video data according to the lossless coding mode to form a reconstructed block of residual video data,
wherein coding the block of residual data comprises bypassing quantization and sign hiding while coding the block of residual video data, and bypassing all loop filters with respect to the reconstructed block of residual video data.
